(19) United States
(12) Patent Application Publication
(10) Pub. No.: US 2023/0284642 A1
(43) Pub. Date: Sep. 14, 2023

(54) DEVICES AND METHODS FOR RELEASE AND DELIVERY OF ACTIVE INGREDIENTS

(71) Applicant: Hazel Technologies, Inc., Chicago, IL (US)

(72) Inventors: Yuan Fang Tham, Chicago, IL (US); Adam Truett Preslar, London (GB)

(73) Assignee: Hazel Technologies, Inc., Chicago, IL (US)

(21) Appl. No.: 18/008,137

(22) PCT Filed: Jun. 4, 2021
(86) PCT No.: PCT/US21/35826

§ 371 Date: Dec. 2, 2022

Related U.S. Application Data
(60) Provisional application No. 63/072,703, filed on Aug. 31, 2020.
(60) Provisional application No. 63/035,564, filed on Jun. 5, 2020.

(51) Int. Cl. A23B 7/152; B65D 81/28

(52) U.S. Cl. CPC A23B 7/152; B65D 81/28

(57) ABSTRACT

Devices and methods for release and delivery of active ingredients such as sprout suppressants are generally described.

### RELATED APPLICATIONS

This application claims priority under 35 U.S.C. § 119(e) to U.S. Provisional Patent Application No. 63/035,564, filed Jun. 5, 2020, and entitled “Devices and Methods for Release and Delivery of Sprout Suppressants,” and to U.S. Provisional Patent Application No. 63/072,703, filed Aug. 31, 2020, and entitled “Devices and Methods for Release and Delivery of Active Ingredients,” each of which is incorporated herein by reference in its entirety for all purposes.

### TECHNICAL FIELD

Devices and methods for release and delivery of active ingredients such as sprout suppressants are generally described.

### BACKGROUND

Potatoes are typically stored for six weeks or longer after harvest. Potatoes are generally stored in rooms below ambient temperatures (e.g., below approximately 21° C.) to mitigate sprouting and extend potato shelf-life. It is also common to treat potatoes with Isopropyl N-(3-chlorophenyl) carbamate (CIPC) during the storage period to inhibit sprouting. However, CIPC fogging treatments are not used after storage once potatoes are removed from the storage rooms and packed for distribution and shipment. Moreover, CIPC is not permitted in organic certified potatoes.

After storage, potatoes are packaged for distribution and shipment in 5-100 lb containers of potatoes, and more typically in containers of potatoes having a weight between 5-50 lbs. A need exists for improved devices and methods for sprout suppression post storage, for example, in packaged potatoes and other crops susceptible to sprouting.

### SUMMARY

Devices, systems, and methods for release and delivery of active ingredients such as sprout suppressants are generally described. The subject matter of the present invention involves, in some cases, interrelated products, alternative solutions to a particular problem, and/or a plurality of different uses of one or more systems and/or articles.

In one aspect, compositions are described. In some embodiments, the composition comprises a porous adsorbent material comprising pores, a supplemental material associated with at least some of the pores, an active ingredient associated with the porous adsorbent material, wherein: the active ingredient is more volatile than the supplemental material, and a total amount of the supplemental material and the active ingredient present in the composition is below a wet point of the porous adsorbent material.

In some embodiments, a composition comprises a porous adsorbent material, a supplemental material within a bulk of the porous adsorbent material, and an active ingredient within a bulk of the porous adsorbent material, wherein the active ingredient is more volatile than the supplemental material.

In some embodiments, a composition comprises a porous adsorbent material comprising a carbon material and/or a silicate material, the porous adsorbent material comprising pores, a supplemental oil associated with at least some of the pores, and spearmint oil or spearmint extract associated with the porous adsorbent material.

In some embodiments, a composition comprises a porous adsorbent material comprising a carbon material and/or a silicate material, the porous adsorbent material comprising pores, a supplemental oil associated with at least some of the pores, and caraway seed oil associated with the porous adsorbent material.

In some embodiments, a composition comprises a porous adsorbent material comprising a carbon material and/or a silicate material, the porous adsorbent material comprising pores, a supplemental oil associated with at least some of the pores, and lemongrass associated with the porous adsorbent material.

In another aspect, methods are provided. In some embodiments, a method comprises releasing an active ingredient from a composition, the composition comprising: a porous adsorbent material comprising pores, the active ingredient associated with the porous adsorbent material prior to the releasing, and a supplemental material associated with at least some of the pores, wherein the active ingredient is more volatile than the supplemental material.

In some embodiments, a method comprises releasing an active ingredient from a delivery material, wherein a rate of the releasing is accelerated by the presence of a supplemental material solely within the delivery material, relative to release in the absence of the supplemental material.

In another aspect, methods of making a composition are provided. In some embodiments, a method of making a composition comprises impregnating a porous adsorbent material with a non-volatile liquid and an active ingredient to form the composition.

In another aspect, methods of suppressing sprouts on produce are provided. In some embodiments, a method comprises releasing a sprout suppressant from a release device into a container containing the produce, wherein the sprout suppressant in the container is maintained at a concentration of at least 1 ppm for a period of at least 3 days.

In some embodiments, a method comprises continuously exposing the produce, over a period of at least 3 days, to a concentration of at least 1 ppm of a sprout suppressant emanating from a release device.

In some embodiments, a method comprises providing a release device comprising the sprout suppressant, placing the release device into a container, and releasing the sprout suppressant into the container, wherein the sprout suppressant in the container is maintained at a concentration of at least 1 ppm for a period of at least 3 days.

In another aspect, release devices are provided. In some embodiments, a release device comprises a porous adsorbent material impregnated with sprout suppressant, wherein the composition is incorporated into a form factor.

In some embodiments, a release device comprises a form factor; and a composition, comprising: a porous adsorbent material, and a sprout suppressant present in the porous adsorbent material.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a cross-sectional schematic illustration of an exemplary composition comprising a porous adsorbent material and an active ingredient associated with the porous adsorbent material, according to some embodiments;

FIG. 1B shows a cross-sectional schematic illustration of an exemplary composition comprising a porous adsorbent material, a supplemental material associated with the porous adsorbent material, and an active ingredient associated with the porous adsorbent material, according to some embodiments;

FIG. 2A shows a cross-sectional schematic illustration of a container containing produce undergoing sprouting in the absence of sprout suppressant released from a release device;

FIG. 2B shows a cross-sectional schematic illustration of a container comprising produce undergoing reduced sprouting in the presence of sprout suppressant released from a release device;

FIGS. 3A-3B show plots of the average loss of spearmint essential oil (SEO) (g) (FIG. 3A) and the SEO loading (wt %) (FIG. 3B) over time in various exemplary compositions lacking supplemental materials, in accordance with some embodiments;

FIGS. 4A-4B show plots of the average loss of spearmint essential oil (SEO) (g) (FIG. 4A) and the SEO loading (wt %) (FIG. 4B) over time in various exemplary compositions comprising supplemental materials, in accordance with some embodiments; and

FIGS. 5A-5B show plots of the average loss of SEO (g) (FIG. 5A) and the SEO loading (wt %) (FIG. 5B) over time in various compositions under various temperature and time period conditions, in accordance with some embodiments.

### DETAILED DESCRIPTION

Release devices and compositions for release of active ingredients such as sprout suppressants, and associated methods, are generally provided. In one aspect, compositions comprising both active ingredients and less volatile supplemental materials are provided. In some such embodiments, the presence of a supplemental material (e.g., a supplemental liquid) may accelerate release of an active ingredient (e.g., such that less active ingredient may be necessary to achieve relatively rapid release). In some embodiments, a release device comprising a sprout suppressant is incorporated into a container containing produce. In some embodiments, a release device comprising a sprout suppressant is incorporated into a container containing crops or produce susceptible to sprouting. In some embodiments, the produce comprises potatoes. In some embodiments, the produce is potatoes.

Release of active ingredients (e.g., volatile active ingredients) can, in some instances, slow down certain biological processes that diminish the quality of agricultural products for their desired uses. For example, active ingredients may be applied to produce at various stages along a supply chain to prolong shelf life. As one example, certain produce such as potatoes may be susceptible to sprouting following harvest, but the sprouting may be reduced, delayed, or even prevented via application of certain active ingredients (e.g., spearmint oil or spearmint extract). Certain existing techniques for applying active ingredients to produce, such as via fumigation, may be poorly suited for certain parts of supply chains because they require significant space, and capital equipment may be required to supply and maintain active ingredient atmospheres. As an example, fumigation may be impractical during shipping or storage, when produce may be contained within relatively small containers. The inventors of the present disclosure have realized that release of active ingredients (e.g., sprout suppressants) can be possible at desirable levels and rates even in relatively small containers. Compositions and release devices described herein can, in some instances, provide for such active ingredient release in a safe, practical, and relatively inexpensive manner. For example, some aspects of this disclosure relate to compositions that can release active ingredients at relatively high rates using relatively small amounts of active ingredient. Such an effect may be due, at least in part, to incorporation of certain supplemental materials into porous adsorbent materials associated with the active ingredient. Additionally, it has been observed that compositions and release devices may be configured to release (e.g., control release) active ingredients such as sprout suppressants into containers of produce at concentrations, and over periods of time, that result in a suppression of sprouting in the produce.

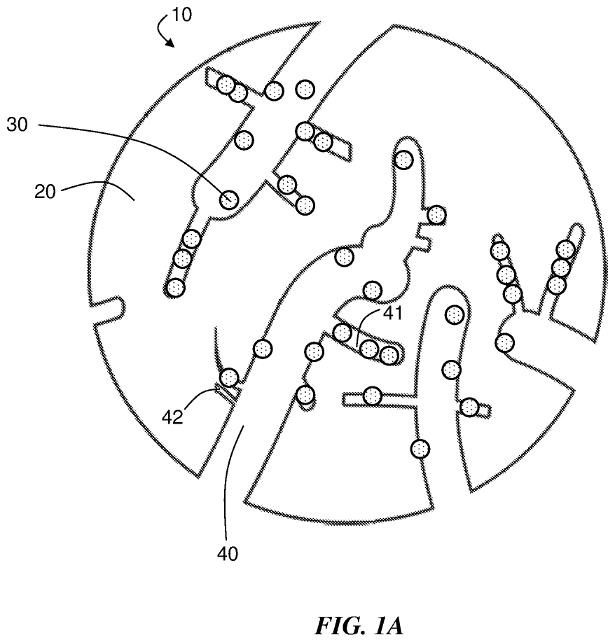

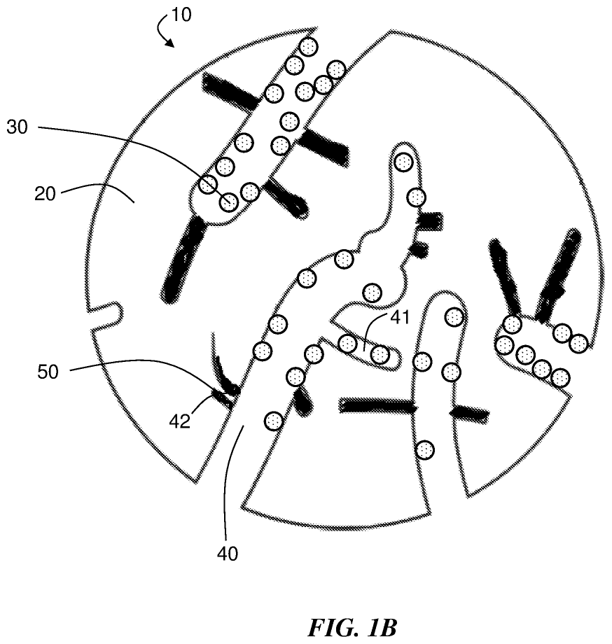

In some embodiments, compositions comprising porous adsorbent materials are described. FIG. 1A shows a cross-sectional schematic illustration of composition 10 comprising porous adsorbent material 20, according to some embodiments. The porous adsorbent material may promote release (e.g., controlled-release) of associated active ingredients, such as sprout suppressants. For example, in FIG. 1A, active ingredient 30 is associated with porous adsorbent material 20 and may be released from composition 10 under certain conditions, according to some embodiments. A variety of potentially suitable porous adsorbent materials may be used with the guidance of this disclosure, including but not limited to carbon material and/or silicate materials. In some embodiments, the porous adsorbent material comprises combinations of porous solids (e.g., soft rocks such as diatomaceous earth). In some embodiments, the porous adsorbent material comprises a gelatinous material. For example, the porous adsorbent material may be collagen-derived (e.g., gelatin). In some embodiments, the porous adsorbent material comprises a mixture of different types of materials (e.g., a mixture that includes both a carbon material and a silicate material, or a mixture that includes both diatomaceous earth and gelatin).

Adsorbent materials are generally capable of associating and retaining a second substance under at least one set of conditions. It should be understood that while adsorbent materials may, in some instances, associate the second substance (e.g., on to internal or external surfaces of the adsorbent) via adsorption, any of a variety of specific or non-specific interactions may contribute to association either alone or in combination, depending on the physical and chemical properties of the respective materials. An adsorbent material may associate other substances in an amount greater than or equal to 0.01 wt %, greater than or equal to 0.1 wt %, greater than or equal to 1 wt %, greater than or equal to 5 wt %, and/or up to 10 wt %, up to 25 wt %, up to 45 wt %, or up to 50 wt % versus the total weight of the adsorbent material and the associated substance.

As described in more detail below, a porous adsorbent material may comprise any of a variety of pores, such as macropores, mesopores, and/or micropores. The presence of pores may promote desirable release profiles for active ingredients (e.g., sprout suppressants) by providing sufficient surface area for association of active ingredients, while in some instances tuning release rates (e.g., by affecting diffusion properties of associated active ingredient). In the illustrative embodiment shown in FIG. 1A, porous adsorbent material 20 comprises macropores 40, mesopores 41, and micropores 42.

As mentioned above, compositions herein may comprise active ingredients. The active ingredients may be associated with a delivery material (e.g., porous adsorbent material) of the composition. The active ingredient may be useful for applications in at least one of agriculture, pest control, odor control, and food preservation. In some embodiments, the active ingredient comprises a sprout suppressant. In other words, the active ingredient may reduce, delay, or prevent sprouting in sprouting-susceptible agricultural products such as sprouting-susceptible produce. The active ingredient may, in accordance with certain embodiments, be or comprise any of the sprout suppressants described below (alone or as mixtures comprising one or more sprout suppressants). For example, the active ingredient may comprise an essential oil such as spearmint oil or spearmint extract (e.g., an oil or extract comprising carvone). As another example, the sprout suppressant may comprise isopropyl-N-(3-chlorophenyl) carbamate. In some embodiments, the active ingredient comprises clove oil, lemongrass, and/or vanillin. In some embodiments, the active ingredient comprises a cyclopropene. The cyclopropene may be any of a variety of cyclopropene derivatives known in the art, such as 1-methylcyclopropene. In some embodiments, the active ingredient comprises jasmonic acid and/or derivatives thereof. In some embodiments, the active ingredient comprises glyoxylic acid and/or derivatives thereof. A derivative of an acid species such as jasmonic acid or glyoxylic acid may be, for example, a conjugate base of the acid (e.g., jasmonate, glyoxylate) or an ester of the acid (e.g., methyl jasmonate, ethyl jasmonate, methyl glyoxylate, ethyl glyoxylate, etc.). In some embodiments, the active ingredient comprises ethyl formate. In some embodiments, the active ingredient comprises a hormone. One example of a potential hormone used as an active ingredient is an insect hormone such as a Lepidopteran hormone.

In some embodiments, the active ingredient is associated with the porous adsorbent material. The active ingredient may be associated with the porous adsorbent material in any of a variety of manners, and methods and devices described herein are not limited to any particular mechanism of association. In some embodiments, the active ingredient is adsorbed to an interior and/or exterior surface of the porous adsorbent material. Adsorption of the active ingredient to a surface may be primarily based on non-specific forces such as van der Waals forces. However, in some embodiments, an active ingredient may be specifically associated with the porous adsorbent material via any of a variety of interactions such as covalent bonds, electrostatic interactions, pi-pi stacking, or specific noncovalent affinity interactions (e.g., via a functional group and/or complexing agent immobilized on a surface of the porous adsorbent material). In some embodiments, the active ingredient is associated with the porous adsorbent material via adhesive forces. For example, a liquid active ingredient may associate with a porous adsorbent material via capillary forces when wetting a surface of the porous adsorbent material.

In some embodiments, the active ingredient is within a bulk of the porous adsorbent material. Being within a bulk of the porous adsorbent material (e.g., within an inner 80% of the macroscopic volume of the porous adsorbent material) as opposed to being solely associated with an outer macroscopic surface of the porous adsorbent material may contribute at least in part to relatively high loadings of the active ingredient as well as a tuning of release rates of the active ingredient. In some embodiments, the active ingredient is within at least some of the pores of the porous adsorbent material (e.g., adsorbed to a surface within pores of the porous adsorbent substrate). For example, in FIG. 1A, active ingredient 30 is present within at least some of macropores 40, mesopores 41, and micropores 42 (e.g., adsorbed to surfaces).

The active ingredient (e.g., sprout suppressant) of the composition may be present in one or more states of matter. For example, the active ingredient may be present as a gas (e.g., gas phase molecules adsorbed to surfaces of the porous adsorbent material). In some embodiments, the active ingredient is present as a liquid (e.g., a liquid impregnating an interior of the porous adsorbent material). In some embodiments, the active ingredient is present in a combination of a liquid phase and a gas phase (e.g., as a volatile liquid with an amount of active ingredient vapor present within a bulk of the porous adsorbent material).

The compositions described herein (e.g., for sprout suppression) may be capable of releasing the active ingredient. As described below, certain compositions and release devices comprising the compositions may be capable of releasing active ingredients (e.g., sprout suppressants) in relatively high amounts for relatively long periods of time. Releasing active ingredients with such release profiles (e.g., controlled-release profiles) may assist in maintaining relatively high concentrations of active ingredients in atmospheres surrounding produce. An ability to maintain such atmospheres for extended periods of time from small and in some instances inexpensive compositions and devices may allow for produce-treatment in situations where treatment would otherwise be impractical (e.g., for preventing sprouting in sprout-susceptible produce in storage and/or shipping containers).

It has been realized in the context of this disclosure that an amount of active ingredient in a composition may affect a rate at which the active ingredient is released from the composition. In has been observed herein that for certain active ingredients (e.g., sprout suppressants such as spearmint oil), greater amounts of active ingredient result in faster release of the active ingredient. Such rapid release may in some instances be beneficial for treating produce (e.g., by suppressing sprouting before significant sprouting occurs). However, some active ingredients can be relatively expensive, and high loadings will increase the costs associated with manufacturing the compositions and devices. Therefore, methods and formulations that promote fast release rates with relatively low loadings of active ingredient can provide for produce treatment at lower costs in some instances.

In this context, it has been discovered that the presence of supplemental materials in the composition may promote desired release characteristics of the active ingredients. For example, in some instances where the release rate of an active ingredient is proportional to an amount of the active ingredient in the composition, the presence of a supplemental material (e.g., a supplemental liquid) may result in a release rate at a first amount of active ingredient otherwise only achievable with a second, greater amount of active ingredient (other factors such as porous adsorbent material, surrounding atmosphere, and temperature being equal). Therefore, it has been unexpectedly discovered that a certain percentage (e.g., greater than or equal to about 5 wt %, greater than or equal to about 10 wt %, greater than or equal to about 15 wt %, and/or up to about 18 wt %, up to about 20 wt %, up to about 23 wt %, up to about 25 wt %, up to about 50 wt %, or more) of an amount of active ingredient associated with a composition (e.g., associated with an porous adsorbent material) may be replaced with a supplemental material. In some such instances, the replacement may have little (e.g., less than about 10%, less than about 5%, less than about 2%, and/or as low as about 1%) or no effect on the release characteristics of the active ingredient compared to an otherwise identical composition in which none of the active ingredient is replaced with supplemental material. For example, in some embodiments, replacing one third of the active ingredient in a composition comprising 3 g of the active ingredient with supplemental material (resulting in a composition comprising 2 g of an active ingredient and 1 g of supplemental material) has little or no effect on the release characteristics of the active ingredient (e.g., active ingredient is released just as fast as the sample having 3 g of active ingredient). However, in some embodiments, the presence of the supplemental material affects the release characteristics of the active ingredient (e.g., via chemical or physical interactions such as outcompeting the active ingredient for surface binding in the porous adsorbent material).

It should be understood that the term “supplemental” material is used herein to distinguish from the active ingredient, which is a different substance than the supplemental material. In some embodiments, the supplemental material is present as a liquid. In some embodiments, the supplemental material is present as a solid. In some embodiments, the supplemental material is a liquid at a first temperature, and is a solid at a second temperature (e.g., the supplemental material may be incorporated into the composition as a liquid at an elevated temperature and then solidify in the composition upon cooling). One such example is non-fractionated coconut oil, which has a melting temperature of 26° C. under standard conditions. Coconut oil may be introduced into the pores of a porous adsorbent material as a liquid at 40° C., and then the coconut oil may solidify in the pores upon cooling of the composition to below 26° C.

The use of the term “supplemental material” is used for convenience, and is not meant to imply any particular physical or chemical properties of the active ingredient. In some embodiments, a supplemental material is present in the composition, and the active ingredient in the composition is in the form of a gas or vapor. However, in some embodiments, the active ingredient is a first liquid in the composition and the supplemental material is a second, different liquid in the composition.

In some embodiments, the supplemental material is associated with the porous adsorbent material. As in the case of the active ingredient, the supplemental material may be associated with the porous adsorbent ingredient in any of a variety of manners, and methods and devices described herein are not limited to any particular mechanism of association. In some embodiments, the supplemental material is adsorbed to an interior and/or exterior surface of the porous adsorbent material. Adsorption of the supplemental material to a surface may be primarily based on non-specific forces such as van der Waals forces. However, in some embodiments, the supplemental material may be specifically associated with the porous adsorbent material via any of a variety of interactions such as covalent bonds, electrostatic interactions, pi-pi stacking, specific noncovalent affinity interactions (e.g., via a functional group and/or complexing agent immobilized on a surface of the porous adsorbent material). In some embodiments, the supplemental material is associated with the porous adsorbent material via adhesive forces. For example, a liquid supplemental material may associate with a porous adsorbent material via capillary forces when wetting a surface of the porous adsorbent material.

In some embodiments, the supplemental material is within a bulk of the porous adsorbent material. Being within a bulk of the porous adsorbent material (e.g., within an inner 80% of the macroscopic volume of the porous adsorbent material) as opposed to being solely associated with an outer macroscopic surface of the porous adsorbent material may contribute at least in part to relatively high loadings of supplemental material, and may contribute to desired release characteristics of the active ingredient (e.g., by filling micropores of the porous adsorbent material). In some embodiments, the supplemental material is within at least some of the pores of the porous adsorbent material (e.g., adsorbed to a surface within pores of the porous adsorbent substrate). For example, in FIG. 1B, supplemental material 50 is present within at least some of micropores 42 (e.g., adsorbed to surfaces), as indicated by the dark coloring filling micropores 42 in FIG. 1B.

Association of the supplemental material with the porous adsorbent material is to be distinguished from other types of liquid interactions solid materials may generally have. For example, supplemental materials described herein stand in contrast to certain existing methods relating to accelerating active ingredient release from materials via external wetting with liquids (e.g., via submersion, suspension, dissolution, etc.). In some embodiments, the supplemental material is present solely within a material of the composition (e.g., a delivery material such as a porous adsorbent material). For example, the supplemental material may be present solely within pores, channels, or other interior regions of the porous adsorbent material.

In some embodiments, the active ingredient (e.g., a sprout suppressant) is released from the porous adsorbent material (e.g., of a release device) without external wetting. In certain embodiments, the active ingredient (e.g., a sprout suppressant) is released from the porous adsorbent material (e.g., of a release device) without external hydrating. In certain embodiments, the active ingredient (e.g., a sprout suppressant) is released from a surface of the porous adsorbent material and directly into a gas or vapor phase.

The supplemental material may comprise any of a variety of suitable liquids. The supplemental material may be chosen based on, for example a low cost (e.g., relative to the cost of the active ingredient). In some, but not necessarily all embodiments, the supplemental material is chemically inert (i.e., non-reactive) with respect to the active ingredient and/or an agricultural product to be treated (e.g., produce) (e.g., under conditions at which the composition is stored or used for treating produce). Further, the supplemental material may be biocompatible (with respect to humans). In some embodiments, the supplemental material is non-fouling or able to be stored without becoming rancid on timescales associated with agricultural material production, storing, shipment, and/or use. In some embodiments, the supplemental material is organic in the context of food and farming methods (e.g., produced without the use of chemical fertilizers, pesticides, or other artificial components).

The volatility of the supplemental material may be an important factor for the supplemental material in some instances. For example, in some embodiments, the active ingredient is more volatile than the supplemental material. In some embodiments, the active ingredient is volatile at at least one temperature relevant to agricultural treatment. For example, in some embodiments, the active ingredient is volatile at at least one temperature from about 263 K to about 313 K (e.g., from about 268 K to about 303 K, from about 272 K to about 288 K, or at about 293 K). In some embodiments, the active ingredient is volatile at some or all of the temperatures in the ranges described above. In some embodiments, the supplemental material is non-volatile at at least one temperature relevant to agricultural treatment. For example, in some embodiments, the supplemental material is non-volatile at at least one temperature from about 263 K to about 313 K (e.g., from about 268 K to about 303 K from about 272 K to about 288 K, or at about 293K). In some embodiments, the supplemental material is non-volatile at some or all of the temperatures in the ranges described above. The relative volatility of two substances generally relates to the vapor pressures of the two substances, with the substance having the greater vapor pressure being considered more volatile. In some embodiments, the active ingredient has a greater vapor pressure than that of the supplemental material under at least one set of conditions (e.g., at about 293 K). In some embodiments, the active ingredient has a vapor pressure of greater than or equal to 0.2 Pa, greater than or equal to 0.5 Pa, greater than or equal to 1 Pa, greater than or equal to about 2 Pa, greater than or equal to about 3 Pa, greater than or equal to about 5 Pa, greater than or equal to about 10 Pa, greater than or equal to about 15 Pa, and/or up to about 20 Pa, up to about 50 Pa, up to about 100 Pa, up to about 200 Pa, up to about 500 Pa, up to about 600 Pa, or greater at at least one temperature (e.g., from about 263 K to about 313 K, from about 268 K to about 303 K, from about 272 K to about 288 K, or at about 293 K). In some embodiments, the supplemental material has a vapor pressure of less than or equal to about 150 Pa, less than or equal to about 100 Pa, less than or equal to about 50 Pa, less than or equal to about 25 Pa, less than or equal to about 20 Pa, less than or equal to about 15 Pa, less than or equal to about 10 Pa, less than or equal to about 8 Pa, less than or equal to about 5 Pa, less than or equal to about 4 Pa, less than or equal to about 3 Pa, less than or equal to about 2 Pa, less than or equal to about 1 Pa, or less at at least one temperature (e.g., from about 263 K to about 313 K, from about 268 K to about 303 K, from about 272 K to about 288 K, or at about 293 K). In some embodiments, the active ingredient has a vapor pressure that is at least about 1.1 times, at least about 1.2 times, at least about 1.5 times, at least about 2 times, at least about 5 times, at least about 10 times, and/or up to 20 times greater or more than that of the supplemental material at at least one temperature (e.g., from about 263 K to about 313 K, from about 268 K to about 303 K, from about 272 K to about 288 K, or at about 293K). A greater volatility of the active ingredient than that of the supplemental ingredient may allow release of the active ingredient to a greater extent than the supplemental material, which can be beneficial when relatively rapid release of the active ingredient is desired.

In some embodiments, the supplemental material comprises an oil. In some embodiments, the supplemental material comprises fatty acids (e.g., oleic acid) in relatively large amounts (e.g., at least about 10 wt %, at least about 25 wt %, at least about 50 wt %, at least about 75 wt %, at least 95 wt %, or greater versus the weight of the supplemental material). In some embodiments, the supplemental material comprises hydrocarbons (e.g., saturated and/or unsaturated, branched or unbranched, cyclic or acyclic hydrocarbons). In some embodiments, the supplemental material comprises hydrocarbons (e.g., higher hydrocarbons such as those having greater than 9 carbons) in relatively large amounts (e.g., at least about 10 wt %, at least about 25 wt %, at least about 50 wt %, at least about 75 wt %, at least 95 wt %, or greater versus the weight of the supplemental material). Having a relatively large amount of fatty acids and/or hydrocarbons may contribute to certain advantageous attributes of the supplemental oil, such as a relatively low volatility, a relatively high viscosity, and in some instances, immiscibility with the active ingredient. In some embodiments, the supplemental material (e.g., a supplemental liquid) is immiscible with the active ingredient (e.g., at a temperature at which the composition is used for treating produce). As mentioned above the supplemental material may be a liquid. In some embodiment, the supplemental material is a liquid at a temperature at which the composition is used for treating produce. In some embodiments, the supplemental material is a liquid at at least one temperature from about 263 K to about 313 K (e.g., from about 268 K to about 303 K or from about 272 K to about 288 K). In some embodiments, the supplemental material is a liquid at some or all of the temperatures in the ranges described above. In some embodiments, a particular binding affinity (as measured by enthalpy of binding) of the supplemental material to the substrate is required such that the active ingredient may be liberated. However, in some embodiments, an excess of supplemental material (e.g., a molar excess) relative to the active ingredient in the composition may be employed to limit an extent of binding of the active ingredient to surfaces of the porous adsorbent material (even with supplemental materials having relatively low binding affinity for the porous adsorbent material).

In some embodiments, the supplemental material comprises one or more vegetable oils. In some embodiments, the supplemental material comprises one or more liquids chosen from canola oil, glycerin corn oil, castor oil, coconut oil, and mineral oil. In some embodiments, the supplemental material comprises a surfactant. In some embodiments, the supplemental material comprises amphiphilic molecules. For example, the supplemental material may comprise molecules having hydrophobic (e.g., polar) components and lipophilic components (e.g., fatty acid tails). In some embodiments, the supplemental material comprises a glycerin ester. Non-limiting examples of suitable glycerin esters include diacylglycerols and triacylglycerols. In some embodiments, the supplemental material comprises a collagen-based substance. In some embodiments, the supplemental material comprises phospholipids. In some embodiments, the supplemental material comprises water (e.g., liquid water). For example, the supplemental material may comprise water in an amount of at least about 10 wt %, at least about 25 wt %, at least about 50 wt %, at least about 75 wt %, at least about 90 wt %, at least about 95 wt %, at least about 98 wt %, at least about 99 wt %, at least about 99.9 wt %, or more. As one example of an embodiment, a composition may comprise a porous adsorbent material comprising a carbon material (e.g., activated carbon) and/or a silicate material, a supplemental material in the form of a supplemental oil, and a sprout suppressant in the form of spearmint oil or spearmint extract or a component thereof (e.g., carvone). Such a composition may be useful, in some instances, in suppressing sprouting in certain produce such as potatoes.

As one example of an embodiment, a composition may comprise a porous adsorbent material comprising a carbon material (e.g., activated carbon) and/or a silicate material, a supplemental material in the form of a supplemental oil, and a sprout suppressant in the form of caraway seed oil or a component thereof (e.g., carvone). Such a composition may be useful, in some instances, in suppressing sprouting in certain produce such as potatoes.

The supplemental material may be present in a relatively high quantity in the composition (which may reduce the overall cost of the composition by reducing an amount of active ingredient necessary to achieve a desired release rate). In some embodiments, the supplemental material is present in the composition (e.g., within a bulk of the porous adsorbent material) in an amount of greater than or equal to about 1 wt %, greater than or equal to about 2 wt %, greater than or equal to about 5 wt %, greater than or equal to about 8 wt %, greater than or equal to about 15 wt %, greater than or equal to about 18 wt %, and/or up to about 20 wt %, up to about 25 wt %, up to about 30 wt %, or more. The amount of supplemental material present may depend on characteristics of the active ingredient or the porous adsorbent material (e.g., based on a percentage of pores being micropores). In some embodiments, a total amount of the supplemental material and the active ingredient present in the composition is below a wet point of the porous adsorbent material. Further description of how to determine a wet point is provided below. By not exceeding a wet point of the porous adsorbent material, the composition may be free of external liquid, which may promote greater durability and flexibility in terms of implementation (e.g., in containers containing produce).

In some embodiments, a ratio of the amount of active ingredient present in the composition to the amount of supplemental material (e.g., supplemental liquid) present in the composition is greater than or equal to about 1:10, greater than or equal to about 1:5, greater than or equal to about 1:4, greater than or equal to about 1:3, greater than or equal to about 1:2, greater than or equal to about 1:1, greater than or equal to about 2:1, greater than or equal to about 3:1, greater than or equal to about 4:1, and/or up to about 5:1, up to about 6:1, up to about 7:1, up to about 8:1, up to about 9:1, up to about 10:1, up to about 20:1, or greater by weight percent. In some embodiments, a ratio of the amount of active ingredient present in the composition to the amount of supplemental material (e.g., supplemental liquid) present in the composition is greater than or equal to about 1:10, greater than or equal to about 1:5, greater than or equal to about 1:4, greater than or equal to about 1:3, greater than or equal to about 1:2, greater than or equal to about 1:1, greater than or equal to about 2:1, greater than or equal to about 3:1, greater than or equal to about 4:1, and/or up to about 5:1, up to about 6:1, up to about 7:1, up to about 8:1, up to about 9:1, up to about 10:1, up to about 20:1, or greater by mole percent. The ratio of the amount of active ingredient present to the amount of supplemental material employed in the composition may depend, for example, on the structure of the porous adsorbent material. For example, in embodiments where a supplemental material accelerates release of active ingredient at least in part by occupying micropores of the porous adsorbent material, a greater microporosity of the porous adsorbent material may lead to a greater amount of supplemental material being employed to achieve a given increase in release rate.

As mentioned above, presence of the supplemental material within the composition may promote accelerated release of the active ingredient. In some embodiments, a composition comprising an active ingredient and a supplemental material is capable of releasing a greater amount of the active ingredient within a period of 50 hours than an otherwise identical composition lacking the supplemental material under essentially identical conditions. In some embodiments, a lesser amount of the active ingredient remains present in the composition after 50 hours (e.g., after 60 hours, after 72 hours, after 100 hours, etc.) of release than an otherwise identical composition lacking the supplemental material under essentially identical conditions. “Essentially identical conditions” in this context refers to other factors that may affect a rate at which an active ingredient is released, such as amount of active ingredient present, type of porous adsorbent material, temperature, and surrounding atmosphere (both in composition and pressure).

There are any of a variety of ways in which the presence of a supplemental material may increase a rate of release of an active ingredient for a given amount of active ingredient present. Without wishing to be bound by any particular theory, it is believed that certain porous adsorbent materials comprising relatively small pores such as micropores may tend to retain associated substances within the relatively small pores (e.g., micropores) even upon equilibration of the system (via release of an amount of the active ingredient). The amount of retained active ingredient may depend on the physicochemical characteristics of the porous adsorbent material, including its pore structure. For example, diffusion within relatively small pores may be mitigated such that the active ingredient may remain associated within the pores even when the active ingredient is relatively volatile. In some such instances, incorporation of a supplemental material may result in some or all of the relatively small pores (e.g., micropores) becoming at least partially filled with the supplemental material instead of the active ingredient. As a result, a larger percentage of the active ingredient in the composition may be in regions of the porous adsorbent material for which release is more facile (e.g., from mesopores, macropores, and other more accessible internal and/or external surfaces). For example, in FIG. 1B, supplemental material 50 may occupy micropores 42 such that a greater percentage of active ingredient 30 is located in macropores 40 and mesopores 41 than in the scenario illustrated in FIG. 1A, in which supplemental material 50 is absent.

As mentioned above, in some instances, the supplemental material is introduced to the porous material in a state of matter different than its state during release of the active ingredient (e.g., during application to produce). In a non-limiting example, coconut oil (which has a melting point of approximately 26° C.) is introduced as a liquid to the porous adsorbent material (either pre-mixed with the active ingredient, or separately) at a temperature of about 40° C., and subsequently allowed to solidify in the porous adsorbent material.

Additionally, and again without wishing to be bound by any particular theory, in some instances the supplemental material may have a greater affinity for adsorbing to surfaces of the porous adsorbent material than does the active ingredient. For example, the supplemental material may have a greater enthalpy of adsorption to the porous adsorbent material than the enthalpy of adsorption of the active ingredient to the porous adsorbent material. Such a difference in enthalpies of adsorption may tend to cause the supplemental material to preferentially adsorb to the surfaces, thereby reducing available surface area for active ingredient adsorption. Alternatively or in addition, the supplemental material may be present in the composition in a molar excess with respect to the active ingredient, such that supplemental material out-competes the active ingredient for interactions with surfaces of the porous adsorbent material (even in some instances where the supplemental material has a lesser binding affinity for the surface than does the active ingredient).

The composition may be prepared using any of a variety of techniques, including those described in more detail below. In some embodiments, preparation of the composition includes impregnating a porous adsorbent material with a supplemental material (e.g., a non-volatile liquid) and an active ingredient to form the composition. For example, the active ingredient and/or the supplemental material may be mixed with the porous adsorbent material to form a mixture, dropped on to the porous adsorbent material (e.g., via a syringe), and the like. In some embodiments, the active ingredient and the supplemental material are first mixed to form a liquid mixture that is then applied (e.g., dropped, mixed with) the porous adsorbent material to achieve impregnation. However, it has been unexpectedly observed that stepwise addition of the supplemental material and the active ingredient can affect the release profile of the resulting composition (e.g., resulting in faster release rates). As one example, in some embodiments, a composition is made by impregnating the porous adsorbent material with the supplemental material (e.g., a non-volatile liquid) to form a liquid-impregnated porous adsorbent material. Then, the resulting liquid-impregnated adsorbent material may be further impregnated with the active ingredient to form the composition.

The compositions described herein relating to active ingredients (e.g., sprout suppressants such as essential oils) may be incorporated into release devices comprising form factors (e.g., sachets), as described in more detail below.

Certain of the release devices, compositions, and the use of compositions as described herein relate to the release or controlled-release delivery of vapor-phase or gas-phase sprout suppressants. In some embodiments, release of the sprout suppressant from the release device functions to reduce or delay sprouting activity of the target produce. In some embodiments, the compositions and use of compositions as described herein relate to the release or controlled-release delivery of vapor-phase or gas-phase sprout suppressants from a porous adsorbent material. A “vapor-phase sprout suppressant” or “gas-phase sprout suppressant” is a sprout suppressant that is released from the porous adsorbent material in the vapor-phase or gas phase, respectively. Generally the vapor-phase sprout suppressant and/or gas-phase sprout suppressant is released at desired conditions (e.g., ambient room temperature (about 20° C.-25° C.) and atmospheric pressure). In an embodiment, the sprout suppressant is in the vapor phase or gas phase in the atmosphere surrounding the produce upon release.

A release device comprises, in accordance with certain embodiments, a porous adsorbent material and at least one sprout suppressant. In some embodiments, the porous adsorbent material comprises a solid material. In some embodiments, the porous adsorbent material is a solid material. In an embodiment, the porous adsorbent material comprises a carbon material. In an embodiment, the porous absorbent material comprises a silica-based material. In an embodiment, the porous adsorbent material is a carbon material. In an embodiment, the porous absorbent material is a silica-based material.

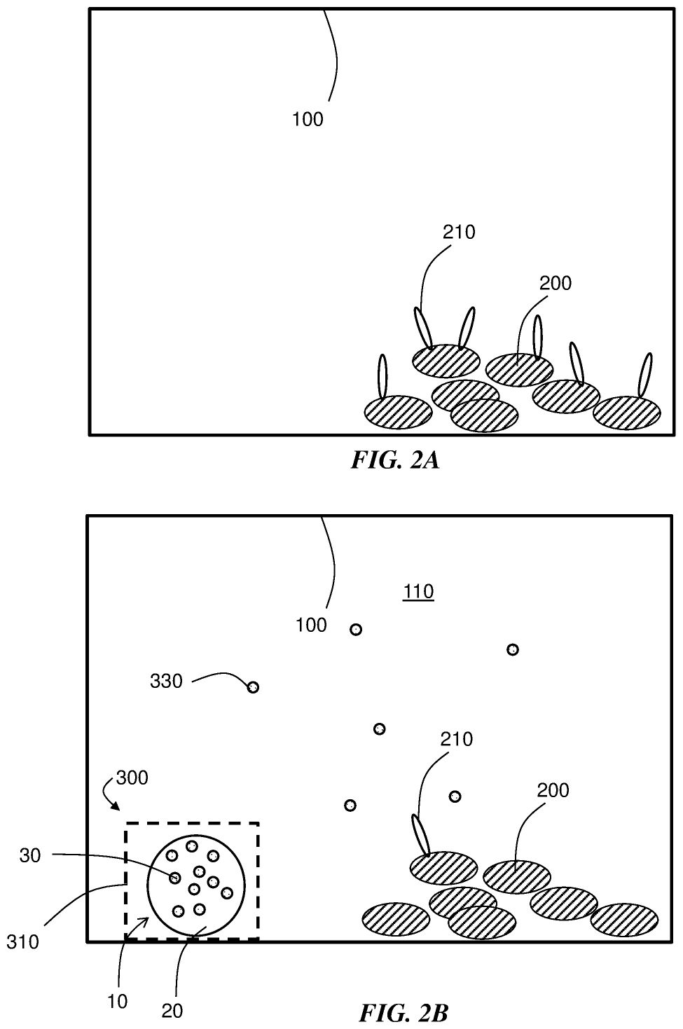

In one aspect, methods of suppressing sprouts on produce are provided. FIGS. 2A-2B show cross-sectional schematic illustrations of how a release device and associated methods may contribute at least in part to a reduction of sprouting on sprout-susceptible produce (e.g., potatoes). FIG. 2A shows container 100 (e.g., a storage or shipping container) containing produce 200 (e.g., potatoes) in the absence of the compositions and release devices described herein. As can be seen in FIG. 2A, produce 200 can grow sprouts 210, which may make the produce unusable for desired applications. In contrast, FIG. 2B illustrates the effect of certain embodiments described herein. In FIG. 2B, container 100 further comprises release device 300 comprising composition 10 comprising optional porous adsorbent material 20 associated with an active ingredient in the form of sprout suppressant 30, in accordance with certain embodiments. Release device 300 may be configured to release sprout suppressant 30 into a surrounding atmosphere (e.g., headspace 110 of container 100). Released sprout suppressant 330 may be maintained in container 100 at a relatively high concentration for a relatively long period of time, as described in more detail below. Such a release of sprout suppressant in a container with produce may suppress sprouting. For example, in FIG. 2B, fewer sprouts 210 are observed on produce 200 than are observed in FIG. 2A.

Suppression of sprouting may be quantified in a variety of ways. For example, under a given set of conditions and after a period of time of exposure to the sprout suppressant in the container (e.g., at least about 3 days and/or up about 75 days), the number of sprouts observed on the produce may be counted and compared to the number of sprouts observed in an identical set of produce in the absence of the sprout suppressant treatment under otherwise essentially identical conditions. As another example, under a given set of conditions and after a period of time of exposure to the sprout suppressant in the container (e.g., at least about 1 day, at least about 3 days and/or up about 75 days), a total weight of sprouts on the produce may be counted and compared to a total weight of sprouts observed in an identical set of produce in the absence of the sprout suppressant treatment under otherwise essentially identical conditions. The total weight may be determined by removing the sprouts from the produce. In some embodiments, methods described herein reduce sprouting on the produce in the container by at least about 25%, by at least about 50%, by at least about 75%, by at least about 90% or more by number of sprouts over a period of 3 days, over a period of 10 days, over a period of 20 days, over a period of 50 days, or over a period of 75 days. In some embodiments, methods described herein reduce sprouting on the produce in the container by at least about 25%, by at least about 50%, by at least about 75%, by at least about 90% or more by total weight of sprouts over a period of 3 days, over a period of 10 days, over a period of 20 days, over a period of 50 days, or over a period of 75 days.

In an embodiment, a release device comprises a composition comprising a porous adsorbent material and at least one sprout suppressant, the at least one sprout suppressant contained within the porous adsorbent material. In an embodiment, the sprout suppressant is adsorbed on one or more surfaces of the porous adsorbent material. In some embodiments, one or more sprout suppressants may be stored in and released from the porous adsorbent materials discussed herein. In a non-limiting embodiment, a composition consists essentially of a porous adsorbent material and at least one sprout suppressant. In a non-limiting embodiment, the composition consists essentially of a carbon delivery material and at least one sprout suppressant. In some embodiments, the sprout suppressant comprises essential oil. In some embodiments, the sprout suppressant comprises spearmint oil. In a non-limiting embodiment, the sprout suppressant consists essentially of spearmint oil. In a non-limiting embodiment, the composition consists essentially of a silica-based delivery material and at least one sprout suppressant. In some embodiments, the sprout suppressant comprises essential oil. In some embodiments, the sprout suppressant comprises spearmint oil. In a non-limiting embodiment, the sprout suppressant consists essentially of spearmint oil. It should be understood that in the context of this disclosure, any of a variety of suitable delivery materials may be used, depending on desired properties of the compositions and release devices (e.g., cost, release profile, etc.). The porous adsorbent materials described herein are one set of examples of delivery materials (e.g., a carbon delivery material can be a carbon porous adsorbent material).

In some embodiments, the one or more sprout suppressants comprises carvone. In some embodiments, the sprout suppressant is carvone. In some embodiments, the sprout suppressant is an essential oil. In some embodiments, the sprout suppressant comprises an essential oil having sprout suppressing qualities. In some embodiments, the sprout suppressant comprises an essential oil comprising carvone. In some embodiments, the sprout suppressant is an essential oil comprising carvone. In some embodiments, the sprout suppressant of the release device may comprise a single essential oil. In other embodiments, the sprout suppressant of the release device may comprise more than one essential oil, for example, two essential oils, three essential oils, four essential oils, or more. The release device may comprise any suitable amount of sprout suppressant.

In some cases, sprout suppressant is present in the porous adsorbent material in at least about 12 wt %, at least about 15 wt %, at least about 20 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, at least about 49 wt %, or at least about 50 wt %, versus the total weight of the porous adsorbent material and the sprout suppressant. In some embodiments, sprout suppressant is present in the porous adsorbent material at between about 12 wt % and about 20 wt %, between about 12 wt % and about 24 wt %, between about 12 wt % and about 25 wt %, between about 12 wt % and about 30 wt %, between 12 wt % and about 40 wt %, between 12 wt % and about 45 wt %, between 12 wt % and about 50 wt %, 15 wt % and about 20 wt %, between about 15 wt % and about 24 wt %, between about 15 wt % and about 25 wt %, between about 15 wt % and about 30 wt %, between 15 wt % and about 40 wt %, between 15 wt % and about 45 wt %, between 15 wt % and about 50 wt %, between about 30 wt % and about 48 wt %, between about 31 wt % and about 48 wt %, between about 35 wt % and about 48 wt %, 30 wt % and about 50 wt %, between about 31 wt % and about 50 wt %, between about 35 wt % and about 50 wt %, between about 35 wt % and about 45 wt %, between about 36 wt % and about 45 wt %, between about 37 wt % and about 45 wt %, between about 38 wt % and about 45 wt %, between about 39 wt % and about 45 wt %, or between about 40 wt % and about 45 wt %, versus the total weight of the porous adsorbent material and the sprout suppressant.

In some cases, sprout suppressant is present in the release device in an amount of at least about 0.04 g, at least about 0.1 g, at least about 0.2 g, at least about 0.4 g, at least about 0.8 g, at least about 1 g, at least about 1.2 g, at least about 2 g, at least about 2.2 g, at least about 3 g, at least about 3.5 g, at least about 4 g, at least about 6 g, at least about 6.5 g, at least about 10 g, at least about 13 g, at least about 20 g, at least about 25 g, at least about 50 g, at least about 100 g, at least about 200 g, at least about 400 g, or at least about 1000 g. In an embodiment, the sprout suppressant comprises spearmint oil. In an embodiment, the sprout suppressant is spearmint oil.

In some cases, sprout suppressant is present in the release device in an amount of up to about 0.05 g, up to about 0.15 g, up to about 0.25 g, up to about 0.5 g, up to about 1 g, up to about 1.2 g, up to about 2 g, up to about 2.5 g, up to about 3.5 g, up to about 4 g, up to about 4.5 g, up to about 7 g, up to about 15 g, up to about 30 g, up to about 50 g, up to about 110 g, up to about 220 g, or up to about 450 g, up to about 1350 g. In an embodiment, the sprout suppressant comprises spearmint oil. In an embodiment, the sprout suppressant is spearmint oil.

In some embodiments, sprout suppressant is present in the release device in an amount of between about 0.04 g and about 0.15 g, between about 0.1 g and about 0.25 g, between about 0.2 g and about 0.45 g, between about 0.2 g and about 0.5 g, between about 0.4 g and about 2.5 g, between about 0.8 g and about 3.5 g, between about 2 g and about 3.75 g, between about 3.5 g and about 4.5 g, between about 4 g and about 6.75 g, between about 6.5 g and about 13.5 g, between about 10 g to about 27 g, between about 25 g to about 55 g, between about 50 g to about 110 g, between about 100 g to about 220 g, between about 220 g to about 450 g, or between about 440 g to about 1350 g. In an embodiment, the sprout suppressant comprises spearmint oil. In an embodiment, the sprout suppressant is spearmint oil.

In some cases, sprout suppressant is present in the release device in an amount of at least about 0.02 g, at least about 0.05 g, at least about 0.1 g, at least about 0.2 g, at least about 0.5 g, at least about 1 g, at least about 2 g, at least about 2.5 g, at least about 3 g, at least about 3.5 g, at least about 5 g, at least about 7 g, at least about 10 g, at least about 15 g, at least about 20 g, at least about 25 g, at least about 30 g, at least about 50 g, at least about 60 g, at least about 65 g, at least about 100 g, at least about 130 g, at least about 200 g, at least about 250 g. at least about 200 g, at least about 400 g, or at least about 1000 g. In an embodiment, the sprout suppressant comprises carvone. In an embodiment, the sprout suppressant is carvone.

In some cases, sprout suppressant is present in the release device in an amount of up to about 0.03 g, up to about 0.07 g, up to about 0.15 g, up to about 0.25 g, up to about 0.3 g, up to about 0.5 g, up to about 0.75 g, up to about 1 g, up to about 1.5 g, up to about 2 g, up to about 2.75 g, up to about 4 g, up to about 8 g, up to about 10 g, up to about 17 g, up to about 25 g, up to about 35 g, up to about 50 g, up to about 67 g, up to about 100 g, up to about 150 g, up to about 200 g, up to about 275 g, or up to about 800 g. In an embodiment, the sprout suppressant comprises carvone. In an embodiment, the sprout suppressant is carvone.

In some embodiments, sprout suppressant is present in the release device in an amount of between about 0.025 g and about 0.075 g, between about 0.5 g and about 0.15 g, between about 0.1 g and about 0.3 g, between about 0.25 g and about 1.5 g, between about 0.5 g and about 2 g, between about 1 g and about 2.5 g, between about 2 g and about 2.75 g, between about 2.5 g and about 4 g, between about 3.75 g and about 8 g, between about 5 g and about 10 g, between about 7 g to about 17 g, between about 15 g to about 35 g, between about 30 g to about 55 g, between about 30 g to about 70 g, between about 65 g to about 150 g, between about 125 g to about 275 g, or between about 250 g to about 800 g. In an embodiment, the sprout suppressant comprises carvone. In an embodiment, the sprout suppressant is carvone.

In an embodiment, the sprout suppressant comprises one or more essential oil. In a non-limiting embodiment, the sprout suppressant is an essential oil and/or botanical extract. In an embodiment the sprout suppressant is organic certified. In some embodiments, essential oils have detectable concentrations of terpenes and/or terpenoids that provide sprout suppressing properties. In a non-limiting embodiment, a sprout suppressant comprises a terpene and/or a terpenoid. Non-limiting examples of terpenes include acyclic and cyclic terpenes, monoterpenes, diterpenes, oligoterpenes, and polyterpenes with any degree of substitution. In a non-limiting embodiment, an essential oil comprises at least one of a terpene, a terpenoid, a phenol, or a phenolic compound. In an embodiment, the sprout suppressant comprises one or more of spearmint oil, caraway seed oil, dill seed oil, orange peel oil, mandarin orange peel oil, kuromoji oil, gingergrass oil, peppermint oil, clove oil, garlic oil, ruta chalepensis L. oil, eucalyptus oil, coriander oil, sagebrush oil, rosemary oil, muna oil, jasmine oil, methyl jasmonate, carvone, and rape oil. In an embodiment, the sprout suppressant comprises carvone. In an embodiment, the sprout suppressant is an essential oil comprising carvone. In an embodiment, the sprout suppressant is selected from the group consisting of spearmint oil, caraway seed oil, dill seed oil, orange peel oil, mandarin orange peel oil, kuromoji oil, gingergrass oil, peppermint oil, clove oil, garlic oil, ruta chalepensis L. oil, eucalyptus oil, coriander oil, sagebrush oil, rosemary oil, muna oil, methyl jasmonate, carvone, rape oil, and combinations thereof. As would be understood by one of ordinary skill in the art, in an embodiment where the sprout suppressant comprises essential oil(s), the weight percent of sprout suppressant in the porous adsorbent material is equivalent to the sum of the weight percentages of the essential oil sprout suppressants present in the porous adsorbent material.

As mentioned above, the sprout suppressant may comprise carvone. It should be understood that carvone has two possible enantiomers. One enantiomer of carvone is (R)-(−)-carvone, and the other enantiomer of carvone is (S)-(+)-carvone. As would be generally understood, references made to a sprout suppressant comprising carvone elsewhere in this disclosure each mean the sprout suppressant comprises one or both enantiomers of carvone. In some embodiments, the sprout suppressant comprises carvone, and at least some (e.g., at least 10 wt %, at least 25 wt %, at least 50 wt %, at least 75 wt %, at least 90 wt %, at least 95 wt %, at least 98 wt %, at least 99 wt %, at least 99.9%, or all) of the carvone of the sprout suppressant is (R)-(−)-carvone. In some embodiments, the sprout suppressant comprises carvone, and at least some (e.g., at least 10 wt %, at least 25 wt %, at least 50 wt %, at least 75 wt %, at least 90 wt %, at least 95 wt %, at least 98 wt %, at least 99 wt %, at least 99.9%, or all) of the carvone of the sprout suppressant is (S)-(+)-carvone. In some embodiments, the sprout suppressant comprises carvone, and at least some (e.g., at least 10 wt %, at least 25 wt %, at least 50 wt %, at least 75 wt %, at least 90 wt %, at least 95 wt %, at least 98 wt %, at least 99 wt %, at least 99.9%) of the carvone of the sprout suppressant is (R)-(−)-carvone and at least some (e.g., at least 10 wt %, at least 25 wt %, at least 50 wt %, at least 75 wt %, at least 90 wt %, at least 95 wt %, at least 98 wt %, at least 99 wt %, at least 99.9%) of the carvone of the sprout suppressant is (S)-(+)-carvone. For example, the sprout suppressant may comprise a racemic mixture of (R)-(−)-carvone and (S)-(+)-carvone.

In some embodiments, the sprout suppressant comprises an essential oil comprising (R)-(−)-carvone. For example, the sprout suppressant may comprise spearmint oil (or spearmint extract), which comprises (R)-(−)-carvone.

In some embodiments, the sprout suppressant comprises an essential oil comprising (S)-(+)-carvone. For example, the sprout suppressant may comprise caraway seed oil, which comprises (S)-(+)-carvone.

In some embodiments, the sprout suppressant comprises citral. In some embodiments, the sprout suppressant comprises an essential oil comprising citral. For example, the sprout suppressant may comprise lemongrass, which comprises citral.

In some embodiments, the sprout suppressant comprises a compound that can affect a biological mechanism of produce, thereby reducing, delaying or eliminating sprouting in the produce. For example, the sprout suppressant may comprise a compound having a moiety that inhibits a biological pathway in the produce that normally leads to sprouting. In some embodiments, the sprout suppressant comprises a compound having a moiety that promotes a biological pathway in the produce that reduces or eliminates sprouting in the produce. As one non-limiting example, it is believed that having an alpha-beta-unsaturated carbonyl group (e.g., an alpha-beta-unsaturated ketone, an alpha-beta-unsaturated aldehyde) can contribute to a compound having sprout-suppressing properties. Examples of compounds described in this disclosure having an alpha-beta-unsaturated carbonyl group include carvone and citral.

In an embodiment, the sprout suppressant comprises 3-decen-2-one and/or 1,4-dimethylnaphthalene. In an embodiment, the sprout suppressant is selected from the group consisting of 3-decen-2-one, 1,4-dimethylnaphthalene, and combinations thereof.

In some embodiments, the sprout suppressant may comprise a single sprout suppressant. In other embodiments, the sprout suppressant may comprise more than one sprout suppressants, for example, two sprout suppressants, three sprout suppressants, four sprout suppressants, or more.

The porous adsorbent material is used, in accordance with certain embodiments, to store and/or release the sprout suppressant. In some embodiments, the sprout suppressant may be in the vapor-phase or gas-phase upon release from the release device. In some embodiments, essential oil having sprout suppressing qualities is released from the composition in the vapor-phase or gas-phase. In some embodiments, spearmint oil is released from the composition in the vapor-phase or gas-phase. In some embodiments, carvone is released from the composition in the vapor-phase or gas-phase.

In some embodiments, caraway seed oil is released from the composition in the vapor-phase or gas-phase.

In some embodiments, the porous adsorbent material comprises one or more of macropores, mesopores, and micropores. In a non-limiting embodiment, macropores are pores having a diameter greater than 50 nm. For example, macropores may have diameters of between 50 and 1000 nm. In a non-limiting embodiment, mesopores are pores having a diameter between 2 nm and 50 nm. In a non-limiting embodiment, micropores are pores having a diameter of less than 2 nm. For example, micropores may have diameters of between 0.2 and 2 nm. Pore diameters may be determined using, for example, the method of Barrett, Joyner, and Halenda in ASTM Standard Test Method D4641-17.

In some embodiments, at least about 10%, at least about 25%, at least about 50%, at least about 75%, at least about 90%, at least about 95%, at least about 98%, at least about 99%, or more of the total pore volume of the adsorbent material is occupied by pores having a pore diameter of at least about 0.1 nm, at least about 0.2 nm, at least about 0.5 nm, at least about 1 nm, at least about 2 nm, at least about 5 nm, at least about 10 nm, at least about 20 nm, at least about 50 nm, or greater. In some embodiments, at least about 10%, at least about 25%, at least about 50%, at least about 75%, at least about 90%, at least about 95%, at least about 98%, at least about 99%, or more of the total pore volume of the adsorbent material is occupied by pores having a pore diameter less than or equal to about 1000 nm, less than or equal to about 500 nm, less than or equal to about 200 nm, less than or equal to about 100 nm, less than or equal to about 50 nm, less than or equal to about 20 nm, less than or equal to about 10 nm, less than or equal to about 5 nm, less than or equal to about 2 nm, or less. Combinations of these ranges are possible.

In some embodiments, the porous adsorbent material is a solid material having a high surface area, as described in more detail herein. Without wishing to be limited by any particular theory or mechanism, porous, high surface area materials are beneficial in this application due to their adsorption capacity and sufficient affinity arising from that adsorption capacity to exhibit volatile retention (e.g. of essential oil) greater than the evaporation retention of a neat liquid. In a non-limiting embodiment, a high-surface area material is a material with a total chemical surface area, internal and external, of at least about 100 m²/g. In some embodiments, a high-surface area material is a material with a total chemical surface area, internal and external, greater than about 400 m²/g. In some embodiments, a high-surface area material is a material with a total chemical surface area, internal and external, of at least about 500 m²/g. In some embodiments, a high-surface area material is a material with a total chemical surface area, internal and external, greater than about 1000 m²/g. In some embodiments, a high-surface area material is a material with a total chemical surface area, internal and external, greater than about 2000 m²/g. The terms “total chemical surface area, internal and external”, “chemical surface area” and “surface area” are used interchangeably herein.

In an embodiment, a porous adsorbent material has a surface area in the range of about 100 to about 1500 m²/g. In an embodiment, a porous adsorbent material has a surface area in the range of about 300 to about 1500 m²/g. In an embodiment, a porous adsorbent material has a surface area in the range of about 500 to about 1500 m²/g. In an embodiment, a porous adsorbent material has a surface area in the range of about 600 to about 1500 m²/g. In an embodiment, a porous adsorbent material has a surface area in the range of about 650 to about 1500 m²/g. In an embodiment, a porous adsorbent material has a surface area in the range of about 650 to about 1300 m²/g. In an embodiment, a porous adsorbent material has a surface area in the range of about 650 to about 1200 m²/g. In an embodiment, a porous adsorbent material has a surface area in the range of about 800 to about 1200 m²/g. In an embodiment, a porous adsorbent material has a surface area in the range of about 850 to about 1200 m²/g. In an embodiment, a porous adsorbent material has a surface area in the range of about 900 to about 1200 m²/g. In an embodiment, a porous adsorbent material has a surface area in the range of about 900 to about 1150 m²/g. In an embodiment, a porous adsorbent material has a surface area in the range of about 900 to about 1500 m²/g. Those of ordinary skill in the will be aware of methods for determining the total chemical surface area, internal and external, for example, using Brunauer-Emmett-Teller (BET) analysis of nitrogen or noble gas desorption when a material (e.g., a porous material) is exposed to vacuum at a given temperature, for instance as by the ISO 9277 standard.

In a non-limiting embodiment, a porous adsorbent material comprises optionally an adsorption-modifying functionality. An adsorption-modifying functionality is any chemical functionality that modifies the interaction between an sprout suppressant and a porous adsorbent material, such that the introduction of the chemical functionality (a) increases or decreases the storage capacity of a porous adsorbent material (with respect to the storage capacity of the delivery material absent that chemical functionality) for sprout suppressant, or (b) accelerates or decelerates the release of sprout suppressant from a porous adsorbent material (with respect to the release of sprout suppressant from the porous adsorbent material absent that chemical functionality). Such modifiable interactions include, but are not limited to, covalent binding, dative binding, electrostatic binding, van der Waals binding, or chelative binding of an appropriate sprout suppressant. A non-limiting example of an adsorption-modifying functionality is one or more hydrophobic groups, for instance trimethylsilyl-functionalities, incorporated in a delivery material via grafting. While the compositions here are not limited to any particular theory or mechanism, it is contemplated that adsorption-modifying functionalities comprising hydrophobic or aliphatic groups in the pore space of the delivery material promote van der Waals interactions with hydrophobic sprout suppressants to help stabilize the hydrophobic sprout suppressants. In a non-limiting embodiment, a porous adsorbent material comprises more than one type of adsorption-modifying functionality.

In a non-limiting embodiment, the composition comprises a porous adsorbent material, being a carbon material, and at least one sprout suppressant. A carbon material may be of various geometries and formations including, but not limited to, macroporous, mesoporous, and microporous carbon materials, monolithic carbon materials, extruded or pelletized carbon materials, steam-activated carbon materials, oxidized carbon materials, or acid- or base-treated carbon materials. In some embodiments, the following carbon materials may be used as porous absorbent materials for the release devices described herein: carbon black (e.g. such as generally indicated by CAS No.: 1333-86-4) or lampblack carbon; activated carbon (also referred to as activated charcoal) (e.g. such as generally indicated by CAS No.: 7440-44-0); carbon in powder, granule, film, or extrudate form; optionally, carbon mixed with one or more adjuvants or diluents; carbon (e.g., activated carbon) sold commercially; carbon derived from coconut, coal, wood, anthracite, or sand (Carbon Activated Corporation) and the like; reactivated carbon; ash, soot, char, charcoal, coal, or coke; vitreous carbon; glassy carbon; bone charcoal. Each of those carbons, whether commercially acquired or manufactured by hand as known in the art can be further modified to form other porous adsorbent materials for the release device described herein by operations including, but not limited to heat treating materials, oxidation, and/or acid- or base-treatment to arrive at other delivery materials and matrices described herein. Therefore, any carbons derived from, for example: carbon black or lampblack carbon, activated carbon or activated charcoal, carbon in powder, granule, film, or extrudate form, reactivated carbon, ash, soot, char, charcoal, coal, or coke, vitreous carbon, glassy carbon, or bone charcoal through the modification of the parent carbon with, for example, adsorption-modifying functionalities, one or more acids, bases, oxidants, hydrolyzing reagents, or a combination thereof may be used to form the compositions described herein. Non-limiting examples of carbon materials are described in U.S. Patent Application Publication No. US 2019/0037839 published on Feb. 8, 2019 and entitled “Compositions for Controlled Release of Active Ingredients and Methods of Making Same,” which is incorporated herein by reference in its entirety for all purposes.

In a non-limiting embodiment, a porous adsorbent material that is a carbon material comprises about 75 wt % to about 100 wt % carbon. In a non-limiting embodiment, a porous adsorbent material that is a carbon material comprises about 80 wt % to about 100 wt % carbon. In a non-limiting embodiment, a porous adsorbent material that is a carbon material comprises about 90 wt % to about 100 wt % carbon. In a non-limiting embodiment, a porous adsorbent material that is a carbon material comprises about 95 wt % to about 100 wt % carbon. In a non-limiting embodiment, a porous adsorbent material that is a carbon material comprises 93 wt % to about 99 wt % carbon. In a non-limiting embodiment, a porous adsorbent material that is a carbon material comprises about 94 wt % to about 98 wt % carbon. In a non-limiting embodiment, a porous adsorbent material that is a carbon material comprises about 90 wt % to about 95 wt % carbon. As would be understood by one of ordinary skill in the art, a carbon material comprising a certain weight percentage of carbon means that carbon is present in the material at that amount. For example, a carbon material comprising about 80 wt % to about 100 wt % carbon means that carbon is present in the carbon material in an amount of about 80 wt % to about 100 wt %.

In some embodiments where the porous adsorbent material comprises a carbon material, a relatively high percentage of the carbon material is elemental carbon (carbon having an oxidation state of 0). In some embodiments, the carbon material comprises elemental carbon in an amount of greater than or equal to 50 atomic percent (at %), greater than or equal to 75 at %, greater than or equal to 90 at %, greater than or equal to 95 at %, greater than or equal to 98 at %, and/or up to 99 at %, or up to 100 at %. In some embodiments, the porous adsorbent material has a relatively high iodine number. In some embodiments, the porous adsorbent material (e.g., a carbon material, a silicate material) has an iodine number of greater than or equal to 0 mg/g, greater than or equal to 100 mg/g, greater than or equal to 200 mg/g, greater than or equal to 500 mg/g, greater than or equal to 800 mg/g, greater than or equal to 1000 mg/g, and/or up to 1200 mg/g, up to 1500 mg/g, up to 2000 mg/g, or higher. Combinations of these ranges (e.g., greater than or equal to 0 mg/g and less than or equal to 2000 mg/g, greater than or equal 500 mg/g and less than or equal to 2000 mg/g, or greater than or equal to 800 mg/g and less than or equal to 1200 mg/g) are possible.

In a non-limiting embodiment, the composition comprises a porous adsorbent material being a silicate material, (also referred to herein as a silica-based material), and at least one sprout suppressant. Silica-based materials generally include silicon atoms and oxygen atoms at least some of which are bound to silicon atoms. The silicon atoms and the oxygen atoms may be present in the silica-based material, for example, in the form of oxidized silicon. Silica-based materials include materials that are or comprise silicon dioxide, other forms of silicates, and combinations thereof. Silica-based materials may include, in addition to the silicon and oxygen atoms, other materials such as metal oxides (e.g., aluminum oxide (Al₂O₃)). Silica-based materials may include organosilicate hybrids. In some embodiments, the amount of silicon atoms, by weight, in the silica-based material is at least about 1 wt %, at least about 3 wt %, at least about 5 wt %, at least about 10 wt %, or at least about 20 wt %. In some embodiments, the amount of oxygen atoms, by weight, in the silica-based material is at least about 1 wt %, at least about 3 wt %, at least about 5 wt %, at least about 10 wt %, or at least about 20 wt %. In certain embodiments, the total amount of the silicon atoms and the oxygen atoms within the silica-based material is at least about 1 wt %, at least about 3 wt %, at least about 5 wt %, at least about 10 wt %, at least about 20 wt %, at least about 25 wt %, at least about 30 wt %, at least about 40 wt %, at least about 50 wt %, at least about 60 wt %, at least about 70 wt %, at least about 80 wt %, at least about 90 wt %, at least about 95 wt %, or at least about 99 wt %.

In a non-limiting embodiment, the porous adsorbent material (e.g., the silica-based material) is or comprises a silicate. Silicates may include neosilicates, sorosilicates, cyclosilicates, inosilicates, phyllosilicates, and tectosilicates. In some embodiments, at least about 1 wt %, at least about 3 wt %, at least about 5 wt %, at least about 10 wt %, at least about 20 wt %, at least about 25 wt %, at least about 30 wt %, at least about 40 wt %, at least about 50 wt %, at least about 60 wt %, at least about 70 wt %, at least about 80 wt %, at least about 90 wt %, at least about 95 wt %, or at least about 99 wt % of the porous absorbent material is made of silicate.

In some embodiments, at least about 1 wt %, at least about 3 wt %, at least about 5 wt %, at least about 10 wt %, at least about 20 wt %, at least about 25 wt %, at least about 30 wt %, at least about 40 wt %, at least about 50 wt %, at least about 60 wt %, at least about 70 wt %, at least about 80 wt %, at least about 90 wt %, at least about 95 wt %, or at least about 99 wt % of the porous adsorbent material is made of silicon dioxide.

A silica-based material may be of various geometries and formations including, but not limited to, macroporous, mesoporous, and microporous silica-based materials, amorphous silica, fumed silica, particulate silica of all sizes, ground quartz, particulate, fumed, crystalline, precipitated, and ground silicon dioxide and associated derivatives, and combinations thereof. In some embodiments, a silica-based material comprises silica gel, or precipitated, crystalline-free silica gel (such as generally indicated by CAS No.: 112926-00-8), or amorphous, fumed (crystalline free) silica (such as generally indicated by CAS No.: 112945-52-5), or mesostructured amorphous silica (such as generally indicated by CAS No.: 7631-86-9). In some embodiments, silica-based material further comprises one or more of a metal oxide, metalloid oxide, and combinations thereof. For example, in some embodiments, the silica-based delivery material further comprises one or more of zinc oxide, titanium oxide, group 13 or 14 oxide, and combinations thereof. In some embodiments, silica-based delivery material further comprises aluminum oxide or a portion of aluminum oxide.

In some embodiments, a delivery material comprising a silica-based material comprises silica. Silicate materials are available from commercial sources in a wide array of states with respect to surface areas, porosities, degrees of surface functionalization, acidity, basicity, metal contents, and other chemical and physicochemical features. Commercial silicates may be in the form of powder, granules, nanoscale particles, and porous particles. In some embodiments, the delivery material comprises silica gel. In some embodiments, the silica-based delivery material comprises silica gel. In some embodiments, the silica-based delivery material comprises one or more of macroporous, mesoporous, and microporous silica. In some embodiments the delivery material comprises precipitated, crystalline-free silica gel (such as generally indicated by CAS No.: 112926-00-8). In some embodiments, the delivery material comprises amorphous, fumed (crystalline free) silica (such as generally indicated by CAS No. 112945-52-5). In some embodiments, the delivery material comprises mesostructured amorphous silica (such as generally indicated by CAS No. 7631-86-9).

In an embodiment, a release device comprises: a composition comprising a porous adsorbent material impregnated with sprout suppressant, the composition incorporated into a form factor. For example, in FIG. 2B, release device 300 comprises optional form factor 310 comprising composition 10. In an embodiment, form factor is, for example, a packet, pouch, sachet, or pad. In an embodiment, the form factor comprises a packet, pouch, sachet, or pad. In a non-limiting embodiment, the composition is incorporated into a form factor by being sealed inside the form factor. In an embodiment, the form factor comprises a porous material. In a non-limiting embodiment, the form factor is comprised of a material that is one or more of food safe, non-absorptive, air permeable (but not necessarily porous). In a non-limiting embodiment, the one or more of food safe, non-absorptive, air permeable (but not necessarily porous) structure comprises a sachet. In a non-limiting embodiment, the sachet is porous. In an embodiment, the porous adsorbent material is charged with sprout suppressant prior to being deposited and sealed in a sachet. For example, the sachet may be prepared by depositing the composition in the sachet and then sealing the sachet.

In an embodiment, the form factor comprises PE (polyethylene) [whether HDPE (high density polyethylene) or LDPE (low density polyethylene)], PLA (polylactic acid), starch, PP (polypropylene), nylon, PET (polyethylene terephthalate), non-woven fabric or paper, paper, burlap (as from jute, hemp or another fiber), cellulose-based material, polyester, or any combination thereof. In an embodiment, the form factor is a sachet which comprises polyethylene (e.g., TYVEK™). In an embodiment, the form factor is a sachet made of polyethylene (e.g., TYVEK™). In a non-limiting embodiment, the sachet may be perforated. In a non-limiting embodiment, the Gurley Hill porosity measurement of a sachet material is 20-50 sec/100 cm²-in, or 30-40 sec/100 cm²-in, or 45-60 sec/100 cm²-in, 60-150 sec/100 cm²-in, or 100-400 sec/100 cm²-in, or 300-400 sec/100 cm²-in. In an embodiment, the form factor material is food-safe. In an embodiment, the sachet material is food-safe.

In a non-limiting embodiment, a release device contains porous adsorbent material in an amount of between about 0.1 g and about 0.25 g, between about 0.25 g and about 0.5 g, between about 0.5 g and about 1 g, between about 1 g and about 5 g, between about 2 g and about 7 g, between about 5 g and about 8 g, between about 8 g and about 10 g, between about 10 g and about 15 g, between about 15 g and about 30 g, between about 30 g and about 60 g, between about 60 g and about 120 g, between about 120 g and 250 g, between about 250 g and about 500 g, between about 500 g and about 1 kg, between about 1 kg and about 3 kg, between about 1 kg and about 3 kg, between about 3 kg and about 5 kg, between about 5 kg and about 10 kg, or between about 10 kg and about 20 kg.

The release device as described herein can be incorporated into produce storage facilities and produce packaging systems in a variety of different manners. In an embodiment, a release device as described herein may be used in containers containing produce, for example, containers for distribution and shipment of produce. In an embodiment, release devices as described herein may be introduced into 5-100 lb containers of potatoes, and more typically in containers of potatoes having a weight between 5-50 lbs. A container comprising the release device can be, for example, a container to which the release device can be permanently or removably affixed. Alternatively, the release device may not be affixed to the container and instead may be placed freely inside the container. In some embodiments, the container is a container open to a surrounding atmosphere (e.g., via an opening (such as a removed lid), holes, and the like). In some embodiments, the container is a closed container (e.g., a substantially fluidically sealed container). In some embodiments, the container may either be an open container or a closed container, depending on how it is configured at a given moment. In some embodiments, the container has a volume of less than or equal to about 10 m³, less than or equal to about 5 m³, less than or equal to about 2 m³, less than or equal to about 1 m³, or less, and/or as low as about 0.5 m³, as low as about 0.1 m³ or less. Certain compositions, release devices, and methods described herein (e.g., related to controlled release of active ingredients such as sprout suppressants) may be useful with relatively small containers, as certain existing methods for sprout suppression such as fumigation may not be suitable for small containers.

In an embodiment, the sprout suppressant is associated with or impregnated in the porous adsorbent material below the threshold of the wet point of the porous adsorbent material. The wet point of the porous adsorbent material is defined as the ratio (or percent) at which a liquid completely fills the vacant volumes (pores) of the porous adsorbent material during titration. When titrating oil into the porous adsorbent material, the wet point is reached when oil begins to collect visibly on the surface of the porous adsorbent material and can be blotted onto a dry piece of Whatman filter paper (Grade 1) from the porous adsorbent material.

Without wishing to be limited by any particular theory or mechanism, it is believed that charging a porous adsorbent material with a sprout suppressant below the wet point of the porous adsorbent material is advantageous because oil added past the wet point will bleed through and potentially corrode the outer form factor material of the release device (for example Tyvek, Mylar, and/or LDPE). For example, if the wet point of a porous adsorbent material is 0.6 g oil:1 g porous adsorbent material, then a formulation having a ratio greater than or equal to 0.6 g oil:1 g porous adsorbent material (or more) will be wet to the touch and potentially “bleed” through packaging, which is undesirable in commercial applications. Additionally, if the wet oil (versus vapor phase sprout suppressant) comes into direct contact with produce, such as potatoes, the produce will effectively be directly rubbed with highly concentrated sprout suppressant (and/or essential oil), which may result in necrosis and strong organoleptic effects. Moreover, in the case of porous adsorbent materials comprising essential oil sprout suppressants in excess of the wet point, for example, the concentration of the representative active volatile in the headspace air will be dominated by the vapor pressure of the neat liquid oil. In that scenario, the representative active volatile in headspace air is not considered to be controlled-release delivery of vapor-phase or gas-phase sprout suppressants.

In an embodiment, the release device is prepared by impregnating a porous adsorbent material with a sprout suppressant. Impregnating, loading, or charging of the porous adsorbent material with sprout suppressant can be performed by the following general method. To the porous adsorbent material is added an amount of essential oil corresponding to an essential oil:porous adsorbent material ratio lower than the wet point. The essential oil and porous adsorbent material mixture is placed into a drum and rolled gently on a drum roller for a period of at least thirty minutes. Using conventional filling methods, the resulting sub-wet point composition is then loaded into a form factor, such as a sachet for commercial use. As will be understood by a skilled artisan, the above procedure may be used with any essential oil or botanical extract sprout suppressant to associate the sprout suppressant with a porous adsorbent material below the wet point of the porous adsorbent material. Additionally, as will be understood by a skilled artisan, the above procedure may be used with non-essential oil/non-botanical extract sprout suppressants such as 3-decen-2-one and/or 1,4-dimethylnaphthalene, for example, to associate the sprout suppressant with a porous adsorbent material below the wet point of the porous adsorbent material. As a skilled artisan will appreciate, different starting weights of the sprout suppressant and porous adsorbent material may be used in order to arrive at a different sprout suppressant weight percentage in the composition.

Measurement of Sprout Suppressant Release from a Release Device

In some embodiments, the release characteristics of sprout suppressant from a release device can be assessed by measuring the concentration of sprout suppressant maintained in the headspace of a container over time. In some embodiments the concentration in the headspace of a container is reported in ppm. As used herein unless otherwise stated, “ppm” means the ratio, in μL/L, of an analyte gas (or representative active volatile) to air as measured at 20° C. and 1 atm pressure. In some embodiments, the concentration of sprout suppressant in a container is calculated via headspace analysis (during a release test as discussed below) of a representative active volatile component of a sprout suppressant in the composition. In some embodiments, the representative active volatile for headspace analysis is a volatile component of one or more sprout suppressant essential oils or sprout suppressant botanical extracts of the composition that is a vapor-phase or gas-phase compound upon release from the composition i) resolvable via gas chromatography (GC) analysis (e.g., the peak can be separated from other GC peaks and the volatile has a commercially available standard), and ii) known to exhibit sprout suppressing activity. In some embodiments, the representative active volatile is the largest contributor to signal when under headspace gas chromatographic analysis. In some embodiments, the representative active volatile is a terpene. In some embodiments, the representative active volatile is carvone. In some embodiments, the representative active volatile is a carvone derivative. In some embodiments, the representative active volatile is eugenol. In some embodiments, the representative active volatile is a eugenol derivative, for example, eugenyl acetate. In a non-limiting embodiment, when a release device comprises spearmint oil or spearmint extract, the concentration of sprout suppressant in a container over time is calculated via headspace analysis (during a release test as discussed below) of carvone. In a non-limiting embodiment, when a release device comprises caraway oil or caraway extract, the concentration of sprout suppressant in a container over time is calculated via headspace analysis (during a release test as discussed below) of carvone. In a non-limiting embodiment, when a release device comprises clove oil or clove extract, the concentration of sprout suppressant in a container over time is calculated via headspace analysis (during a release test as discussed below) of eugenol. In a non-limiting embodiment, when a release device comprises clove oil or clove extract, the concentration of sprout suppressant in the headspace of a container over time is calculated via headspace analysis (during a release test as discussed below) of eugenyl acetate. It will be understood by those skilled in the art that, for a pure compound measured via headspace analysis (e.g., carvone, eugenol, or eugenyl acetate), molar and mass quantities are interconvertible, and that either may be converted to volume for a gas, provided temperature, pressure, and the molecular weight of the gas are known, as determined using the ideal gas law.

An example method for determining the concentration of sprout suppressant maintained in a container over time is discussed below. It will be understood by those skilled in the art that, for release tests relying on headspace analysis of a representative active volatile, terpene, carvone, eugenol, or eugenyl acetate, the compound sampled is used as a proxy to report the concentration of sprout suppressant in the container. In other words, the concentration of sprout suppressant in a container is reported to be equivalent to the concentration of the selected representative active volatile of the sprout suppressant measured.

Concentration of a sprout suppressant in a container over time during a release test is determined is as follows. A release device comprising sprout suppressant is placed in a sealed, air-tight container. The volume of the container for the release test is selected in accordance with the following ratio −0.061 g of sprout suppressant (i.e. representative active volatile): 1 L container volume. For example, a release test to measure the concentration of sprout suppressant maintained over time for release device comprising 0.915 g of carvone should be tested in a container having a volume of 15 L. The container has or is modified with a septum port for non-invasive gas sampling. As described below, during the release test, a sample of the sprout suppressant released into the container is collected using conventional headspace methodologies (such as employing a gas-tight syringe for sampling) and measured (e.g. using a gas chromatograph (GC)) after an established period of time, as discussed below.

A non-limiting example of how to measure the concentration of sprout suppressant in a container is as follows. The release study commences at time zero, immediately after the release device is placed into the container and the container is sealed (e.g. by closing the lid). In an embodiment, the container is permitted to equilibrate for the 24 hours following time zero. A sample of the sprout suppressant released from the release device over the 24 hours after time zero is collected (e.g. using conventional headspace methodologies). The sample of sprout suppressant is then measured (e.g., using a gas chromatograph (GC)). As the release test continues and until the end of the release test, to measure the concentration of sprout suppressant maintained in the container over time, every 24 hours following the first sample, the container is vented by briefly (e.g. by removing the lid of the container and then closing the lid). For this release test method, it is important that the container have 24 hours to build concentration prior to each new sample taken from the container.

Those with ordinary skill in the art will be aware of conventional headspace methodologies that use, for example, gas chromatography (GC). A non-limiting example of a method that uses headspace analysis to measure concentration of sprout suppressant is provided as follows. The release device comprising sprout suppressant, is placed in a septum-equipped container discussed above. The area of the GC peak may be calibrated by comparison against an internal standard. In each instance, the flame ionization detector (FID) response of the GC instrument is calibrated by the injection of variable quantities of a known standard of the pure analyte and using methods understood to those skilled in the art. In some embodiments, the pure analyte is the representative active volatile as discussed above.

GC measurement of a headspace concentration in ppm using an established calibration will be understood by those skilled in the art. Again, as used herein unless otherwise stated, “ppm” means the ratio, in μL/L, of an analyte gas (or representative active volatile) to air as measured at 20° C. and 1 atm pressure. For a release test as discussed above, the concentration of sprout suppressant in a container is calculated using the equation below:

$$\frac{A * C * 24,000,000}{V} = Concentration ( ppm ) ,$$

wherein:
A=peak area from GC-FID result from the sample gas injection into the GC,
C=Slope of the linear GC calibration in mol/arbitrary signal, and
V=Volume of the sample gas injection into the GC (in L).

In an embodiment, for calculating the release of carvone (for example, as a proxy for assessing the release of spearmint oil) from a release device, the area of the GC peak may be calibrated against known quantities of carvone. Carvone is obtainable as a 98.5% pure liquid (for example, from Sigma Aldrich chemical company) which may be dissolved to a known concentration in a solvent (e.g. hexane, pentane, or methanol) and injected as a solution of known concentration for GC measurement. In an embodiment, for calculating the release of eugenol (for example, as a proxy for assessing the release of clove oil) from a release device, the area of the GC peak may be calibrated against known quantities of eugenol. Eugenol is obtainable as a 99% pure liquid (for example, from Sigma Aldrich chemical company) which may be dissolved to a known concentration in a solvent (e.g. hexane, pentane, or methanol) and injected as a solution of known concentration for GC measurement. In a non-limiting embodiment, the release of an essential oil sprout suppressant may be calculated based on headspace sampling of its representative active volatile during a release test as discussed above. It should be understood that throughout the duration of the release tests, temperature and atmospheric pressure around the release device is kept substantially constant.

In an embodiment, the concentration of sprout suppressant in the container measured at each time point of the release test is at least 1 ppm. In an embodiment, the sprout suppressant is carvone.

In an embodiment, the concentration of sprout suppressant in the container is maintained at a concentration of at least 1 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least 1.5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least 2 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least 2.5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least 3 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least 3.5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least 4 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least 4.5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least 5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least 5.5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of between about 0.75 ppm to about 1.5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of between about 0.90 ppm to about 1.5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of between about 0.90 ppm to about 1.25 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of between about 1 ppm to about 1.25 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of between about 1 ppm to about 1.5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration, sprout suppressant in the container is maintained at a concentration of between about 1 ppm to about 2 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of between about 1 ppm to about 3 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of between about 1 ppm to about 4 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of between about 1 ppm to about 5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is concentration of between about 1 ppm to about 5.5 ppm for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days.

In an embodiment, the concentration of sprout suppressant in the container is maintained at a concentration of at least about 0.5 ppm, at least about 0.1 ppm, at least about 0.01 ppm, at least about 1 ppm, at least about 2 ppm, at least about 3 ppm, at least about 4 ppm, at least about 5 ppm, or greater for a period of up to 10 days, up to 25 days, up to 40 days, up to 50 days, up 75 days, up to 100 days, or up to 150 days, or more.

The concentration of sprout suppressant at which the container is maintained may affect both an extent of sprout suppression achieved as well as resulting properties of the produce. In some instances, the concentration employed is such that a balancing of competing effects is achieved. For example, it has been observed that relatively high levels of some, but not necessarily all sprout suppressants over the time periods mentioned above may cause taste effects in the resulting produce (e.g., potatoes). The ranges of sprout suppressant concentrations described above have been observed, in some instances, to be sufficiently high to suppress sprouting in some produce, while not so high as to cause undesirable taste effects in that produce.

In an embodiment, the concentration of sprout suppressant in the container is maintained at a concentration of up 6 ppm, up to 8 ppm, up to 10 ppm, or greater for a period of at least 3 days, or at least 4 days, or at least 5 days, or at least 6 days, or at least 7 days, or at least 8 days, or at least 9 days, or at least 10 days, or at least 12 days, or at least 15 days, or at least 20 days, or at least 25 days, or at least 30 days, or at least 35 days, or at least 40 days, or at least 45 days, or at least 50 days, or at least 55 days, or at least 60 days, or at least 75 days, or more.

In some embodiments, a porous adsorbent material releases and/or is configured to release the active ingredient at a temperature. In this context, the temperature refers to the temperature of the area surrounding the site of release of the active ingredient (e.g., sprout suppressant). For example, in embodiments in which the active ingredient (e.g., sprout suppressant) is released in a container (e.g., comprising produce such as potatoes), the temperature refers to an average temperature in that container (e.g., as measured by one or more thermometers within the enclosure). The temperature at which the porous adsorbent material releases that active ingredient (and/or is configured to release the active ingredient) may be measured, for example, placing a thermocouple in contact with fluid (e.g., gas such as air) in the area surrounding the site of release of the active ingredient (e.g., sprout suppressant).

In some embodiments, the release device (e.g., comprising the porous adsorbent material) releases and/or is configured to release the active ingredient (e.g., sprout suppressant) at a temperature of greater than or equal to −2° C., greater than or equal to −1° C., greater than or equal to 0° C., greater than or equal to 2° C., greater than or equal to 4° C., greater than or equal to 10° C., greater than or equal to 15° C., greater than or equal to 20° C., or greater. In some embodiments, the release device (e.g., comprising the porous adsorbent material) releases and/or is configured to release the active ingredient (e.g., sprout suppressant) at a temperature of less than or equal to 50° C., less than or equal to 40° C., less than or equal to 30° C., less than or equal to 25° C., less than or equal to 22° C., less than or equal to 20° C., less than or equal to 15° C., less than or equal to 11° C., less than or equal to 10° C., less than or equal to 6° C., or less. Combinations of these ranges are possible. For example, in some embodiments, the release device (e.g., comprising the porous adsorbent material) releases and/or is configured to release the active ingredient (e.g., sprout suppressant) at a temperature of greater than or equal to −2° C., and less than or equal to 50° C., greater than or equal to −2° C. and less than or equal to 30° C., greater than or equal to 2° C. and less than or equal to 25° C., or greater than or equal to −2° C. and less than or equal to 15° C.

In some embodiments, the temperature of the porous adsorbent material (which, in this context, refers to the spatially averaged temperature of the porous adsorbent material) during the release of at least a portion (e.g., at least 10 wt %, at least 25 wt %, at least 50 wt %, at least 75 wt %, at least 85 wt %, at least 95 wt %, at least 99 wt %, or all) of the active ingredient (e.g., sprout suppressant) is greater than or equal to −2° C., greater than or equal to −1° C., greater than or equal to 0° C., greater than or equal to 2° C., greater than or equal to 4° C., greater than or equal to 10° C., greater than or equal to 15° C., greater than or equal to 20° C., or greater. In some embodiments, the temperature of the porous adsorbent material during the release of at least a portion (e.g., at least 10 wt %, at least 25 wt %, at least 50 wt %, at least 75 wt %, at least 85 wt %, at least 95 wt %, at least 99 wt %, or all) of the active ingredient (e.g., sprout suppressant) is less than or equal to 50° C., less than or equal to 30° C., less than or equal to 25° C., less than or equal to 22° C., less than or equal to 20° C., less than or equal to 15° C., less than or equal to 11° C., less than or equal to 10° C., less than or equal to 6° C., or less. Combinations of these ranges are possible (e.g., greater than or equal to −2° C. and less than or equal to 50° C.; greater than or equal to −2° C. and less than or equal to 30° C.; greater than or equal to 2° C. and less than or equal to 25° C.; greater than or equal to 2° C. and less than or equal to 6° C.; greater than or equal to −2° C. and less than or equal to 15° C.).

“Produce” as used herein and above means post-harvest agricultural and horticultural products that have a propensity toward sprouting. Examples of produce that may be treated by the compositions and release devices described herein include, but are not limited to various roots, tap roots, tubers, stem roots, rhizomes, and bulbs such as potatoes (Solanum tuberosum), sweet potato, yam, taro, ginseng, cassava, dahlia, onions (Allium sp.), shallot, turnip (Brassica rapa), ginger (Zingiber officinale), and carrots (Daucus). Additional examples of produce that may be treated by the compositions and release devices described herein include, but are not limited to, hog potato or groundnut (Apios americana), tigernut or chufa (Cyperus esculentus), yam (Dioscorea spp.), Chinese yam (Dioscorea polystachya), Jerusalem artichoke or sunchoke (Helianthus tuberosus), daylily (Hemerocallis spp), earthnut pea (Lathyrus tuberosus), oca or New Zealand yam (Oxalis tuberosa), kembili and dazo (Plectranthus edulis and P. esculentus), Chinese artichoke (Stachys affinis), mashua or ariu (Tropaeolum tuberosum), ulluku (Ullucus tuberosus), turmeric (Curcuma longa), ginseng (Panax ginseng), rengarenga and vanilly lily (Arthropodium spp.), canna (Canna spp.), ti (Cordyline fruticosa), arrowroot (Maranta arundinacea), lotus root (Nelumbo nucifera), cattail or bulrush (Typha spp.), ginger (Zingiber officinale), native ginger (Hornstedtia scottiana), yellow lily yam (Amorphophallus galbra), pignut or earthnut (Conopodium majus), sweet potato (Ipomoea batatas), desert yam (Ipomoea costata), cassava or yuca or manioc (Manihot esculenta), manuka or chago (Mirabilis expansa), breadroot, tipsin, or prairie turnip (Psoralea esculenta), yacón (Smallanthus sonchifolius), arracacha (Arracacia xanthorrhiza), beet and mangelwurzel (Beta vulgaris), rutabaga and turnip (Brassica spp.), black cumin (Bunium persicum), burdock (Arctium, family Asteraceae), celeriac (Apium graveolens rapaceum), daikon (Raphanus sativus var. longipinnatus), dandelion (Taraxacum spp.), maca (Lepidium meyenii), murnong or yam daisy (Microseris lanceolata), jicama and ahipa (Pachyrhizus spp.), parsnip (Pastinaca sativa), parsley root (Petroselinum spp.), radish (Raphanus sativus), salsify (Tragopogon spp.), black salsify (Scorzonera hispanica), skirret (Sium sisarum), or bush carrot or bush potato (Vigna lanceolata). Further examples of produce that may be treated by the compositions and release devices described herein include, but are not limited to, konjac (Amorphophallus konjac), taro (Colocasia esculenta), Chinese water chestnut (Eleocharis dulcis), enset (Ensete spp.), Nelumbo nucifera, waterlily (Nymphaea spp.), Pteridium esculentum, arrowhead or wapatoo (Sagittaria spp.), Typha spp., malanga, cocoyam, tannia, or yautia (Xanthosoma spp.), or eddoe or Japanese potato (Colocasia antiquorum).

The release device can be stored or transported, for example, in vapor-impermeable packaging. In some embodiments, the release device may be transported in hermetically sealed packaging. In an embodiment, the release device is stored or transported in oxygen impermeable packaging. In an embodiment, the release device is stored or transported in water vapor (e.g., water in the gas-phase) impermeable packaging.

U.S. Provisional Patent Application No. 63/035,564, filed Jun. 5, 2020, and entitled “Devices and Methods for Release and Delivery of Sprout Suppressants,” and U.S. Provisional Patent Application No. 63/072,703, filed Aug. 31, 2020, and entitled “Devices and Methods for Release and Delivery of Active Ingredients,” are each incorporated herein by reference in its entirety for all purposes.

These and other aspects will be further appreciated upon consideration of the following Examples, which are intended to illustrate certain particular embodiments of the invention but are not intended to limit its scope, as defined by the claims.

### Example 1

### Release Device Manufacture

A non-limiting example of an illustrative process for manufacturing a release device as described herein follows. Activated carbon (in extrudate form) having a wet point of 45.66%, is placed into a vessel that allows ready mixing of the active oil with the granular carbon material. 100 g of spearmint oil (Jedwards International) is added to 125 g of the activated carbon. When adding the spearmint oil to the carbon material, care is taken to ensure even contact between the spearmint oil and the activated carbon. Even contact between the oil and activated carbon may be achieved, for example, by forming a packed bed of the activated carbon, placing a single aliquot of the spearmint oil at the top of the bed, and allowing the oil to percolate through the bed until the all the activated carbon in the vessel is evenly exposed or until uptake of the oil is complete. A vertical packed bed column may be used for this purpose and a compressed air source may optionally be used to expedite progression of the oil. This results in a composition comprising at least 44.4 wt % spearmint oil. The resulting mixture is placed into a drum and rolled gently on a drum roller for 30 minutes. The resulting composition may be divided as desired and loaded into form factor(s), for example a TYVEK® sachet(s) using conventional methods. As a skilled artisan will appreciate, the above procedure may be repeated with any essential oil or botanical extract having sprout suppressing properties as long as the association of the activated carbon and the sprout suppressant is accomplished below the wet point.

### Example 2

Another non-limiting example of an illustrative process for manufacturing a release device as described herein follows. Silica gel (in powder form) having a wet point of 45.66% is placed into a vessel that allows ready mixing of the active oil with the silica gel. 100 g of spearmint oil (Jedwards international) is added to 125 g of the silica gel. When adding the spearmint oil to the silica material, care is taken to ensure even contact between the spearmint oil and the silica material. Even contact between the oil and silica powder may be achieved, for example, by the rolling, agitation, or mixing of the silica during the continuous or aliquoted delivery of the oil to the porous adsorbent material. A drum and drum roller may be used for this purpose. This results in a composition comprising at least 44.4 wt % spearmint oil. The resulting composition may be divided as desired and loaded into form factor(s), for example a TYVEK® sachet(s) using conventional methods. As a skilled artisan will appreciate, the above procedure may be repeated with any essential oil or botanical extract having sprout suppressing properties as long as the association of the activated carbon and the sprout suppressant is accomplished below the wet point.

As a skilled artisan will appreciate, as long as the sprout suppressant and the porous adsorbent material is combined below the wet point, different weight combinations of the sprout suppressant and the porous adsorbent material may be used in order to arrive at a different weight percentage of sprout suppressant in the final composition.

A non-limiting specific example of a release device is below.

### Sample 1

Activated carbon in extrudate form (0.8 mm Extrudate, Cabot Corporation) having a wet point of 49.9% is placed into a vessel that allows ready mixing of the sprout suppressant with the extrudate carbon material. 1.2 g of spearmint oil (for example, having >60 wt % carvone, Sigma Aldrich) is added to 1.5 g of the extrudate activated carbon. When adding the spearmint oil to the activated carbon, care is taken to ensure even contact between the spearmint oil and the extrudate activated carbon material by iterating between pouring a portion of the oil into the carbon material, mixing for a brief period, and adding again. This results in a composition comprising approximately 44.4 wt % spearmint oil. The mixture is then agitated and loaded into a TYVEK® sachet using conventional methods.

Release Test from Sample 1—

The concentration of sprout suppressant from the release device of Sample 1 maintained in a container was determined using headspace analysis of sealed boxes containing 2.7 g of the Sample 1, as measured with a gas chromatograph (GC) equipped with a flame ionization detector. The release device was placed in a 15 L sealed, air-tight container. In this experiment, “time zero” was defined as the instant that the 15 L container was sealed after placing the release device of Sample 1 in the container. The release device is permitted to release sprout suppressant into the container for the 24 hours following time zero. During the release test, a sample of the sprout suppressant released into the container after 24 hours is collected using a gas-tight syringe and measured using a gas chromatograph (GC). The GC oven start temperature was set to 140° C. The area of the GC peak for carvone was calibrated by comparison to known areas of an authentic carvone standard (98.5%, Sigma Aldrich) to determine the concentration of sprout suppressant in the container. The release test was conducted at 20° C. at atmospheric pressure.

The container was briefly vented every 24 hours following the first sample (for example, removing the lid of the container and then closing it). As the release test continues and until the end of the release test, when a sample is taken, it is done using a gas-tight syringe to sample headspace concentration prior to each venting.

The concentration of carvone over 12 days is given blow in Table 1. The concentration (in ppm) was calculated in accordance with the method discussed previously for release tests for measuring concentration of sprout suppressant in a container. Concentration of sprout suppressant in the container is reported as a function of representative active volatile carvone. The concentration of carvone from Sample 1 accumulated in the container was calibrated using known quantities of carvone injected into the instrument.

TABLE 1
Concentration of Sprout Suppressant over maintained
in a 15 L container over 12 days

| Time (hrs) | Concentration (ppm) |
|---|---|
| 24 | 1.258 |
| 48 | 1.089 |
| 288 | 1.028 |

Produce Efficacy Test from Sample 1— Sprout Suppression in Organic Potatoes

A study was conducted on size A organic potatoes to study the effect of release of sprout suppressant from the release device of Sample 1 on produce. Organic red potatoes were obtained from Alsum Farms and Produce after having been kept in commercial storage conditions for 10 months at 35° F. To eliminate potential bias in assessing sprout incidence, all potatoes were screened to remove any potatoes with sprouts or peeps observed on the buds prior to the start of the experiment. For each replicate, 10 random potatoes (without sprouts or peeps) were selected and placed in a 15 L airtight container. For the treated sets of potatoes, a release device characterized by 3 cm×5 cm sachet (TYVEK®, Dupont) filled with 2.7 g of the composition of Sample 1 was placed in the 15 L container with the potatoes. No release device was placed in the 15 L containers with control (untreated) potatoes. A total of 6 replicates were studied for the experiment, 3 for treated and 3 for control.

During the efficacy test, potatoes were held at 68° F. and 65% relative humidity for 12 days. All containers were vented each day by opening the lid for 5 seconds and closing it again. On days 0, 4, 8, and 12 of the experiment, each potato in the containers were individually inspected by a technician. For a given potato, each potato having any visible sprout were indicated as FAIL; each potato having no visible sprout growth were indicated as PASS.

The treated group showed a significantly lower number of sprouted potatoes (i.e. a significantly lower number of FAILs). From these results, it is concluded that the release device of Sample 1 is sufficient to suppress (i.e. delay) sprouting in commercially available potatoes for at least 8 days.

A total of 60 potatoes were evaluated in the experiment. Table 2 shows the percentage of sprouted potatoes indicated as FAIL.

TABLE 2
% Potatoes indicated as FAIL over 12 days

Evaluation Day

| Group | 0 | 4 | 8 | 12 |
|---|---|---|---|---|
| Untreated Control | 0% | 100% | 100% | 100% |
| Treated | 0% | 53% | 53% | 97% |

The efficacy test results presented above indicate the commercial relevance of the performance of release devices as discussed herein.

An advantage of the release devices disclosed herein is that they may be easily integrated into commodity food product packaging of varying sizes, for example 5-50 lbs containers. Moreover, the release devices disclosed herein may be used to deliver sprout suppressants to produce commodities in multiple levels of the supply chain, for example in the packhouse, during inventory, transit, and/or in end-consumer sized packaging. In an embodiment, the sprout suppressants present in the release devices are organic certified. In an embodiment, the release device is organic certified.

### Example 3

This example describes the effect of the presence of supplemental materials in certain porous adsorbent materials on the release characteristics and loading considerations for a non-limiting active ingredient, in accordance with certain embodiments. In this non-limiting set of embodiments, activated carbon was employed as a porous adsorbent material, and a spearmint oil (which can be a sprout suppressant) was employed as an active ingredient to be released. Release rates of the spearmint oil were recorded as a function of amount of spearmint loaded. Further, release rates of the spearmint oil were recorded in the presence of a variety of supplemental materials (referred to in this example as “supplemental materials”) in the form of various non-volatile oils.

### Measurement Apparatus

A measurement apparatus for recording active ingredient release profiles was comprised of a mass balance (capable of massing to within ±0.001 g), a Petri dish, aluminum foil, a 500 mL amber glass jar with a lid, a matrix, and spearmint essential oil (SEO) having a greater than 60% carvone content (Jedwards International, Inc., Braintree Mass., Lot #Z1819A05).

### Weighing Measurement Protocol for Quantifying SEO Loss

The following section describes the method used to determine the Spearmint Essential Oil (SEO) present in SEO-loaded carbon by measuring the weight loss of SEO-loaded carbon over time, with the result being expressed as weight %. SEO loaded carbon was massed and placed in an aluminum foil wrapped petri dish. The mass of the aluminum foil wrapped petri dish was recorded. At certain time points, the mass of the petri dish with the SEO loaded carbon was massed. The mass loss over time was assumed to be solely contributed by the release of SEO from the carbon.

The calculations described in this section were used to determine the mass loss of SEO (g) over time and the wt % loading of supplemental material and/or SEO over time. In the calculations, P=mass of petri dish (g), C=mass of SEO loaded carbon (g), I=initial mass of SEO loaded (g), M=mass of petri dish+SEO loaded carbon at each time point (g), and D=mass of supplemental material added (g).

$$M - P = Mass of SEO loaded carbon at each time point ( g ) \qquad ( 1 )$$

$$C - ( 1 ) = Mass loss of SEO ( g ) \qquad ( 2 )$$

$$I - ( 2 ) = Mass of SEO remaining in the carbon ( g ) \qquad ( 3 )$$

$$\frac{( 2 )}{I} * 100 \% = Loss of SEO over time ( \% ) \qquad ( 4 )$$

$$\frac{( 3 ) + D}{1} * 100 \% = \% loading of SEO and Diluent on Carbon ( wt \% ) \qquad ( 5 )$$

### Experiment Protocol for Experiments 1, 2, and 3

### Properties of Materials:

Activated carbon having a surface area of 650 m²/g was selected as a porous adsorbent material, as indicated in Table 3, and 5 different supplemental materials were selected, as indicated in Table 4.

TABLE 3
Physical characteristics of the carbon porous adsorbent
material and SEO used in Experiments 1, 2, and 3.
Physical Characteristics

| Matrix type | Activated Carbon |
|---|---|
| Mesh size | 20 × 40 |
| Surface area (m²/g) | 650 |
| pH | 4.6 |
| Iodine No. (mg/g) | 600 |
| Molasses decolorizing efficiency | 95 |
| Total pore volume (mL/g) | 0.95 |
| Wet point (% by total mass) | 45 |
| Percentage of carvone in SEO (%) | 60.94 |

TABLE 4
Properties of supplemental materials used in Experiments 1, 2, and 3

| | Supplemental Materials | | | | | | |
|---|---|---|---|---|---|---|---|
| | Canola | Corn | Fractionated | Castor | Mineral | | |
| Properties | oil | oil | Coconut oil | oil | oil | Water | SEO |
| Saturated FA | 6 | 16 | 90 | 6 | 100 | — | — |
| Unsaturated | 92 | 84 | 9 | 94 | — | — | — |
| FA | | | | | | | |
| Price ($/kg) | 3.81 | 2.30 | 3.22 | 5.36 | 0.40 | — | 49.00 |
| Smoke | 450 | 440 | 320 | 392 | — | — | — |
| point ° F. | | | | | | | |
| Smoke | 191 | 227 | 160 | 200 | — | — | — |
| point ° C. | | | | | | | |
| Freezing/Melting | <0 | <−11-8 | <−5-−15 | <−2-10 | −60-9 | 0 | — |
| Point range ° C. | | | | | | | |
| Cloud Point | −3 | −14-11 | ≤−5 | — | — | — | — |
| range ° C. | | | | | | | |

### Methodology—Experiment 1

To begin, 200 g of carbon porous adsorbent material was weighed out into 500 mL amber glass jars with 50 g in each jar. The glass jars were placed in the oven to dry out the porous adsorbent material at 150° C. for 24 hours. Then, a layer of aluminum foil was wrapped tightly around each of 12 petri dishes, which were then weighed and labelled accordingly. The mass of each petri dish was recorded. Respective amounts of carbon porous adsorbent material prepared from the first step was weighed out according to Table 5 and placed in a clean 500 mL amber glass jar, which was then placed on a mass balance. A 10 mL syringe with a needle attachment was used to slowly drip the SEO on to the porous adsorbent material (Table 5). For homogenous loading, the SEO was dripped on different locations around the porous adsorbent material instead of the same spot. After 5 drips, the jar was closed with a lid and shaken vigorously for 30 seconds. These steps were repeated until the desired amount of SEO was loaded. Each of the SEO-loaded porous adsorbent materials were poured into the petri dishes, respectively. The petri dishes were placed on a rack and placed in an open and clean fume hood with a constant flow velocity of 100 ft/min. Every day, the position of the racks was randomized and rotated 180° to ensure even air flow throughout all treatments. After a fixed time, the petri dish with SEO loaded carbon was weighed. The experiment was performed in triplicates.

TABLE 5
Experiment 1 treatment set up

| Treatment | 18% | 28% | 30% | 38% |
|---|---|---|---|---|
| Mass of | 8.2 | 5.0 | 7.0 | 5.0 |
| carbon (g) | | | | |
| Mass of SEO | 1.8 | 2.0 | 3.0 | 3.0 |
| (g) | | | | |

### Methodology—Experiment 2

To begin, 200 g of carbon porous adsorbent material was weighed out into a 500 mL amber glass jars with 50 g matrix in each jar. The glass jars were placed in the oven to dry out the matrix at 150° C. for 24 hours. Then, a layer of aluminum foil was wrapped tightly around 21 petri dishes, which were then weighed and labelled accordingly. The mass of each petri dish was recorded. 5 g of respective carbon porous adsorbent material prepared from the first step was weighed out and placed in a clean 500 mL amber glass jar, which was then placed on a mass balance. A 10 mL syringe with a needle attachment was used to slowly drip the supplemental materials on to the matrix (Table 6). For homogenous loading, the supplemental material was dripped on different locations around the matrix instead of the same spot. After 5 drips, the jar was closed with a lid and shaken vigorously for 30 seconds. These steps were repeated until the desired amount of supplemental material was loaded. The material was transferred to a 15 mL conical tube and sealed for 2 hours to allow the supplemental material to equilibrate. After 2 hours, SEO (Table 6) was loaded onto the supplemental material-impregnated porous adsorbent material using the same method described above. These steps were repeated for each supplemental material treatment. Each of the SEO and/or supplemental material loaded porous adsorbent material was poured into a petri dish, respectively. The petri dishes were placed on a rack and placed in an open and clean fume hood with a constant flow velocity of 100 ft/min. Every day, the position of the racks was randomized and rotated 180° to ensure even air flow throughout all treatments. After a fixed time, the petri dish with SEO loaded carbon marked for ‘Weight’ was weighed. The experiment was conducted in triplicates.

TABLE 6
Experiment 2 Setup.

| | Supplemental Material | | | | | | |
|---|---|---|---|---|---|---|---|
| | | | | | | | No |
| | | | | | | | Supple- |
| Treatment | Canola | Castor | Coconut | Mineral | Water | SEO | mental |
| Mass of | 5.0 | 5.0 | 5.0 | 5.0 | 5.0 | 5.0 | 5.0 |
| carbon (g) | | | | | | | |
| Mass of | 1.0 | 1.0 | 1.0 | 1.0 | 1.0 | 0 | 0 |
| supple- | | | | | | | |
| mental | | | | | | | |
| material | | | | | | | |
| (g) | | | | | | | |
| Mass of | 2.0 | 2.0 | 2.0 | 2.0 | 2.0 | 3.0 | 2.0 |
| SEO (g) | | | | | | | |

### Methodology—Experiment 3

The same methodology and set up described in Experiment 2 were used for Experiment 3. However, the time and temperature used to equilibrate the supplemental oil was altered according to the table shown (Table 7). The temperature was achieved by placing the sealed conical tubes containing the supplemental material loaded porous adsorbent material materials in a water bath adjusted to the appropriate temperature. Once the treatment was completed, steps to load the supplemental material onto the matrix were conducted.

TABLE 7
Experiment 3 Setup

| | | | | | | | | No |
|---|---|---|---|---|---|---|---|---|
| Supplemental | | | | | | | | supple- |
| Materials | Canola, Coconut, Castor, Mineral Oil | | | | | | SEO | mental |
| Treatment | 2/20 | 2/40 | 2/80 | 24/20 | 24/40 | 24/80 | SEO | No |
| Code | | | | | | | | Supple- |
| | | | | | | | | mental |
| Mass of | 5.0 | 5.0 | 5.0 | 5.0 | 5.0 | 5.0 | 5.0 | 5.0 |
| carbon (g) | | | | | | | | |
| Mass of | 1.0 | 1.0 | 1.0 | 1.0 | 1.0 | 1.0 | 0 | 0 |
| supplemental | | | | | | | | |
| material (g) | | | | | | | | |
| Mass of SEO | 2.0 | 2.0 | 2.0 | 2.0 | 2.0 | 2.0 | 3.0 | 2.0 |
| (g) | | | | | | | | |
| Time (hours) | 2 | 2 | 2 | 24 | 24 | 24 | 2 | 2 |
| Temperature | 20 | 40 | 80 | 20 | 40 | 80 | 20 | 20 |
| (° C.) | | | | | | | | |

Results from Experiment 1

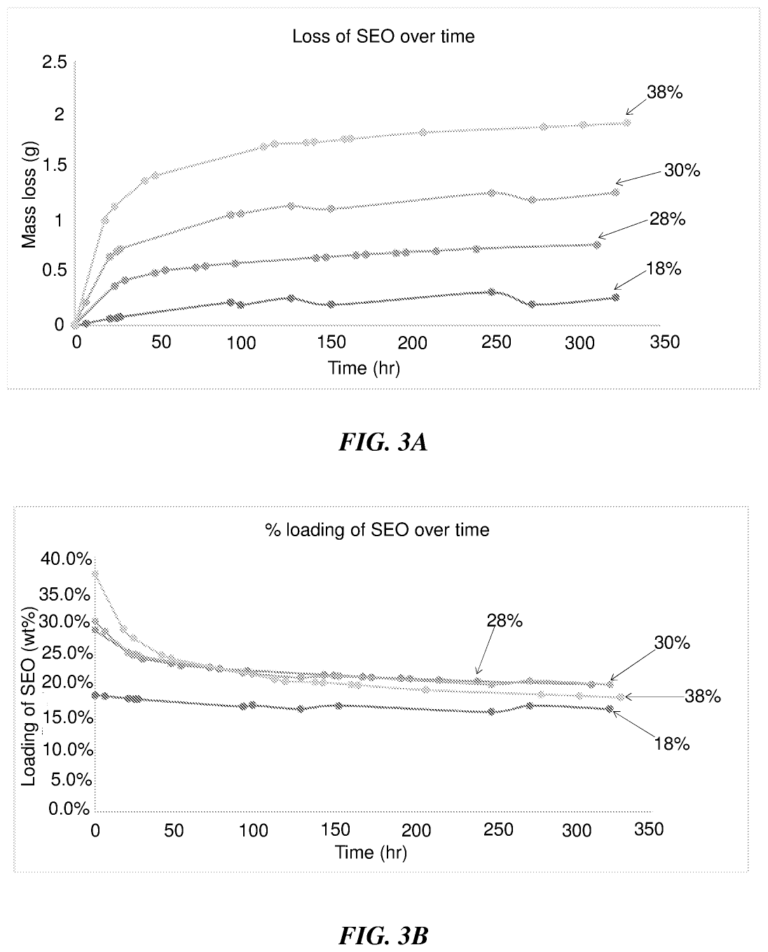

The porous adsorbent material was initially loaded with different amounts of SEO to arrive at a different initial SEO loading by wt %. The mass loss of the treatments was attributed solely to the loss of SEO over time. FIGS. 3A-3B show plots of the average loss of SEO (g) (FIG. 3A) and the SEO loading (wt %) (FIG. 3B) over time in the four samples of Experiment 1. The higher the mass of SEO added per unit gram of carbon, the higher the SEO loss through the porous adsorbent material due to the vapor pressure of volatiles exerted. However, the equilibrium wt % of the loading leveled off at about 15-23%, indicating that there was about 20 wt % of SEO that was ultimately retained (likely adsorbed onto the micropores of the porous adsorbent material) and not released. In summary, the higher the amount of initial SEO loading by wt %, the higher the total release of SEO over time due to the higher vapor pressure exerted at a higher concentration of SEO. When the vapor pressure reaches equilibrium, SEO is not released anymore. Due to the cost of SEO, it was realized in the context of this set of experiments that it could be more economically viable to occupy the 15-23 wt % of micropores of the porous adsorbent material with a cheaper, sacrificial material. Therefore, experiments 2 and 3 addressed the occupation of micropores with supplemental materials.

Results from Experiment 2

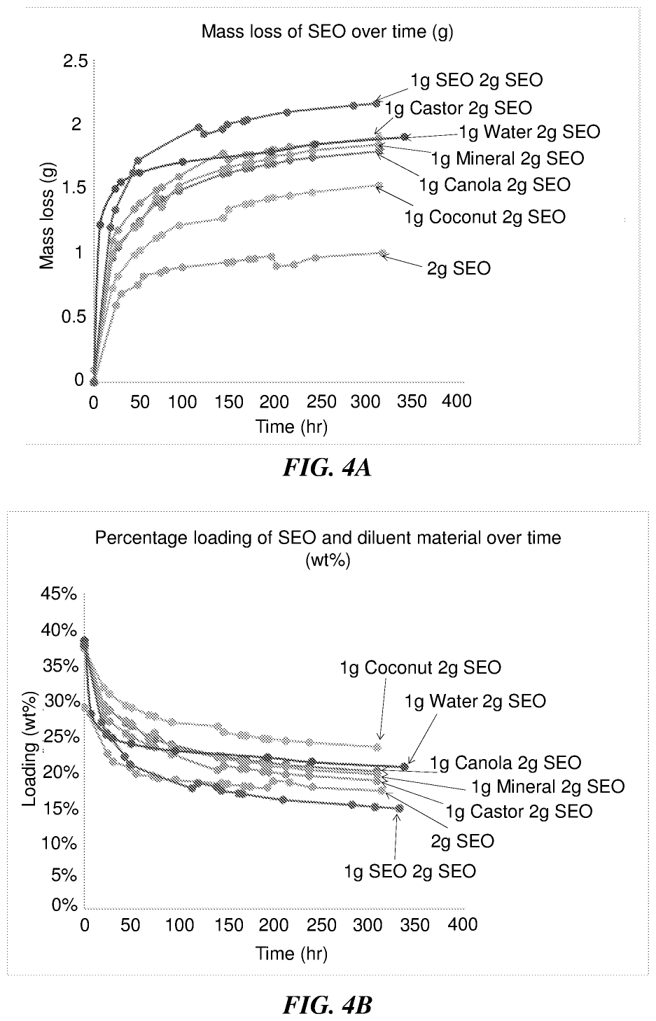

When 1 g of supplemental material was added to the porous adsorbent material (e.g., to occupy the micropores), an increase in SEO mass loss compared to the treatment without supplemental materials added (2 g SEO) was observed. FIGS. 4A-4B show plots of the average loss of SEO (g) (FIG. 4A) and the SEO loading (wt %) (FIG. 4B) over time in the six samples of Experiment 2. There were no significant differences between the SEO mass loss between the canola, castor, corn, water, and mineral oil treatments, but coconut oil had a significantly lower release compared to the other supplemental material treatments. When SEO was added as the supplemental material (1 g SEO 2 g SEO), the mass loss of SEO was the highest. When water was added as a supplemental material, fast release of the SEO was observed, where 75 wt % of the SEO was released within the first 50 hours. This indicated that even though the addition of supplemental material was able to achieve the goal of occupying the micropores in the matrix, the high boiling point of supplemental material decreased the volatility of the overall mixture. Therefore, a balance between micropore occupation and volatility of mixture would need to be achieved. In summary, the addition of supplemental material increased the loss of SEO from the matrix compared to the treatment without supplemental material added over the time periods measured. It was also observed that addition of water as a supplemental material altered the release profile to a fast release system, where the highest rate of initial release of SEO is observed of any of the samples tested in this experiment. Additionally, all treatment groups still arrived at an equilibrium wt % loading of 18-23%, suggesting that a proportion of supplemental material occupied the micropores of the porous adsorbent material. Lastly, when SEO was added as the supplemental material, the highest mass loss of SEO was observed, which indicated that the supplemental material decreased the volatility of SEO. When Canola, Corn, Fractionated Coconut, Castor and Mineral oils were added as supplemental materials respectively, the release rate of SEO increased compared to the control treatment (without supplemental material). However, when SEO was added as the supplemental material in addition to the initial SEO added, the release rate of SEO was the highest. It is believed that by loading supplemental material onto the carbon first, supplemental material was able to occupy a portion of the micropores and allow more SEO to occupy the meso and macropores of the carbon porous adsorbent material for higher release. However, since the supplemental materials had a lower volatility compared to SEO, the supplemental material treatment decreased the overall volatility of materials in the composition.

Results from Experiment 3

Since there were no significant differences between the release profiles of the different supplemental materials, data from mineral oil was selected due to it being the most economically viable choice. For the treatment groups, 1 g of supplemental material was loaded onto the porous adsorbent material and subjected to different time and temperature processes, as shown in Table 7 above. For the groups without supplemental material added (“No Supplemental” and “SEO”), the SEO was loaded onto the carbon porous adsorbent material for 2 hours with no heat, as heat could degrade the SEO compounds.

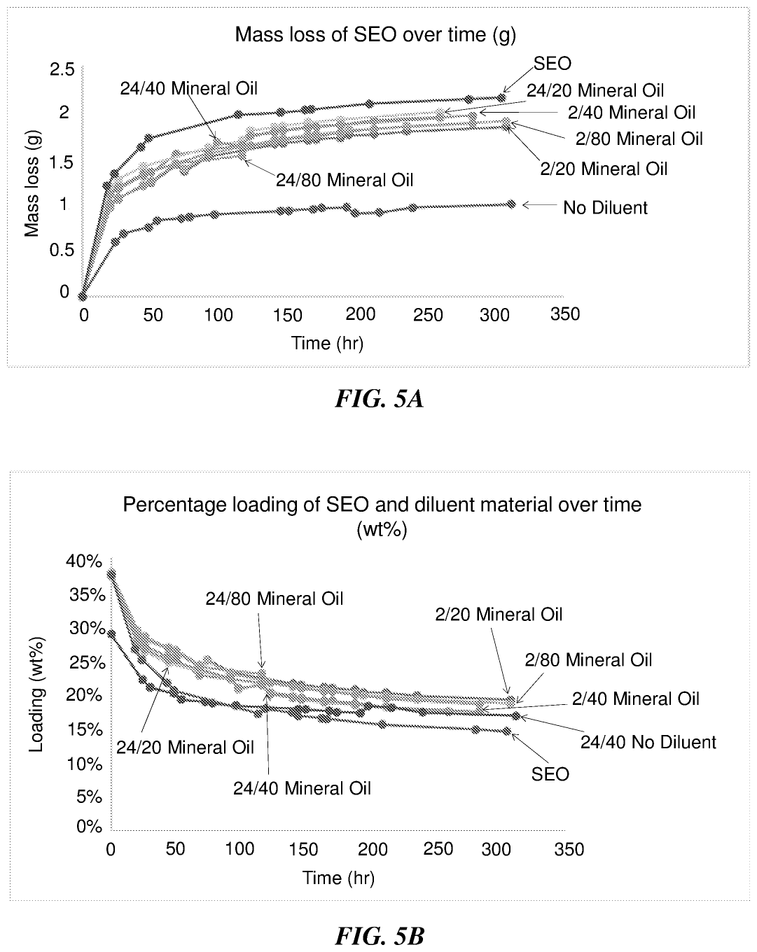

It was hypothesized that by heating the sample, it would allow the supplemental materials to overcome the kinetic barrier to penetrate further into the micropores, allowing the porous adsorbent material to adsorb the supplemental materials first. However, no significant differences were observed when time and temperature were added, which indicated that the kinetic barrier of supplemental materials penetrating to micropores was low, and could be achieved rapidly even at room temperature. FIGS. 5A-5B show plots of the average loss of SEO (g) (FIG. 5A) and the SEO loading (wt %) (FIG. 5B) over time in the eight samples of Experiment 3. In summary, heat and time did not affect the extent or rate at which the supplemental materials enter the micropores of the porous adsorbent material, suggesting that heat and time is not needed for this preparation method.

### Conclusion

Table 8 shows provides a summary of the formulations and release profiles of the compositions tested in this example.

TABLE 8
Summary of compositions tested in Experiments 1, 2, and 3

| | | | | | SEO | No |
|---|---|---|---|---|---|---|
| Supplemental Materials | Canola | Castor | Coconut | Mineral | 3 g | Supplemental |
| Average of Mass of | 5.0093 | 5.0645 | 4.9979 | 4.9993 | 5.0440 | 5.0327 |
| uncharged matrix (g) | | | | | | |
| Average of Initial mass of | 2.0160 | 2.0217 | 2.0150 | 2.0163 | 3.0213 | 2.0187 |
| SEO added (g) | | | | | | |
| Average of Initial mass of | 0.9947 | 0.9972 | 1.0031 | 1.0067 | 0.0000 | 0.0000 |
| supplemental added (g) | | | | | | |
| Average of Initial mass of | 3.0107 | 3.0188 | 3.0181 | 3.0230 | 3.0213 | 2.0187 |
| supplemental + SEO (g) | | | | | | |
| Average of total mass loss | 1.7900 | 1.8927 | 1.5253 | 1.8397 | 2.1797 | 1.0003 |
| over time (g) | | | | | | |
| Average of final wt % | 20% | 18% | 23% | 19% | 14% | 17% |
| loading over time | | | | | | |
| (Supplemental + SEO) | | | | | | |
| gSEO/gMatrix | 0.4025 | 0.3992 | 0.4032 | 0.4033 | 0.5990 | 0.4011 |
| gSEO + Supplemental/gMatrix | 0.6010 | 0.5961 | 0.6039 | 0.6047 | 0.5990 | 0.4011 |
| Total Release as % of | 82% | 87% | 70% | 84% | 100% | 46% |
| target (SEO 3 g) | | | | | | |
| Total SEO needed to reach | 2.4549 | 2.3282 | 2.8794 | 2.3890 | 3.0213 | 4.3986 |
| release target (SEO 3 g) | | | | | | |
| Total SEO relative to | 81% | 77% | 95% | 79% | 100% | 146% |
| target case | | | | | | |

For this comparison, the release profile of “SEO 3 g” treatment was selected as the target release, as this treatment had the highest total release of SEO over time. In comparison to the formulation without supplemental oil, 146% more SEO was required to be initially loaded to achieve the release target amount. However, when supplemental materials (Canola, Castor and Mineral oil) were added into the formulation, a 20% reduction of total SEO required to achieve the target release was observed. This indicates that inclusion of supplemental materials can reduce the amount of active ingredients needed in a composition to achieve a given release profile. When inexpensive supplemental materials are chosen, such a reduction in active ingredient can lower the costs associated with preparing compositions for treating agricultural products (e.g., suppressing sprouting in produce).

### Example 4

This example describes the efficacy of certain non-limiting active ingredients for sprout suppression upon release from a release device. In this non-limiting set of experiments, activated carbon was employed as a porous adsorbent material, and certain essential oils were tested and compared. Essential oils of spearmint (Jedwards International Lot #Z1819A2), caraway (Lebermuth Lot #1808001659), lemongrass (Lebermuth Lot #1807001122), and coriander (Wholesale Botanics), with main active components of (R)-(−)-carvone, (S)-(+)-carvone, citral, and linalool, respectively, were deployed. Sprout suppression efficacy for fingerling potatoes were assessed, and headspace concentration profiles of these active ingredients during exposure to the potatoes were measured.

### Methodology

A loaded matrix for each experiment was prepared by massing 2.8 g of an activated carbon having a surface area of 650 m²/g and placing it into a 500 mL jar. 2.2 g of the essential oil to be tested was poured onto the activated carbon. The jar was agitated by shaking for at least one minute. A total of 15.0 g of each type of matrix was made for this Example.

A sachet for each experiment was made by cutting a 7″×1.5″ strip of sachet material (TYVEK®, Dupont). The strip was folded over (long axis) and impulse sealed on the long sides (temp level 6, 1 second on, 1 second cool). The sachet was filled with 5 g of loaded matrix and impulse-sealed on its short side to close.

The potato tubers were set up as follows. Organic fingerling potato (Scientific name: Solanum tuberosum, Variety: Russian Banana) were obtained from Albert Bartlett after having been kept in commercial storage conditions for 7 months at 1.67° C. The potatoes had been treated with clove oil via thermo-fogging application during commercial storage. To eliminate potential bias in assessing sprout incidence, all potatoes were sorted and randomized across the experiments of this Example. Defective and/or sprouted tubers were removed to ensure a uniform initial condition. For each replicate, 800 g of fingerling potatoes (˜30 potatoes) were placed in a 15 L storage box with a sealed lid and a septum attached for headspace gas chromatography (GC) sampling. The experiments for the various essential oil active ingredients were conducted in triplicate.

The storage conditions of the potatoes during the experiments were as follows. The sachet was taped to an interior side of the storage box directly opposite the sampling port and kept for 10 days at 20° C. and 35% relative humidity. The control boxes did not receive a sachet. Each container was vented each day by removing the lid for 5 seconds and closing it again. A total of 18 true replicates were studied for the experiment, 3 for each treatment (Table 9).

Data was recorded at day 0 (the day on which the sachet was introduced into the sealed boxes), day 2, day 5, day 7, and day 9. During data collection, the mass of each sachet was determined with a 3 decimal point analytical scale, and all potatoes from each replicate were evaluated. Each potato having any visible sprout was indicated as FAIL; each potato having no visible sprout was indicated as PASS.

The headspace concentration for the active ingredient at each data collection time point was determined as follows. The sealed storage box was agitated via shaking for 5 seconds. Then, a 1 mL gas-tight syringe was inserted through the septum and pumped five times in to homogenize the headspace gases. A 400 μL gas sample was removed and injected into a GC-FID for analysis. The mass of injected active ingredient was determined via comparison to a calibration curve for each relevant active ingredient. Calibration curves were created by direct inject of known concentrations of active ingredient. The mass of active ingredient measured was converted to a ppm value using the following formula:

$$ppm = \frac{( ( peak area * calibration factor ) + calibration intercept )}{molar mass * injection volume} * 24$$

The experimental design and evaluation time points are summarized in Table 9.

TABLE 9
Experiment design and evaluation time points

| | | | Number of | |
|---|---|---|---|---|
| Treatment | Number of | | potatoes per | Evaluation |
| Group | replicates | Replicate | replicate | days |
| Control | 3 | 1 | 31 | Day 0 |
| | | 2 | 31 | Day 2 |
| | | 3 | 31 | Day 5 |
| Spearmint | 3 | 1 | 29 | Day 7 |
| | | 2 | 36 | Day 9 |
| | | 3 | 29 | |
| Caraway | 3 | 1 | 27 | |
| | | 2 | 28 | |
| | | 3 | 28 | |
| Lemongrass | 3 | 1 | 29 | |
| | | 2 | 28 | |
| | | 3 | 30 | |
| Coriander | 3 | 1 | 34 | |
| | | 2 | 36 | |
| | | 3 | 36 | |

### Results

The results of the experiments are described below, both in terms of visual evaluation of sprouting extent and quantitative measurement of active ingredient concentration time profiles in the storage containers.

Table 10 shows the percentage of potatoes indicated as FAIL at the various evaluated time points. Peeps were observed in control, spearmint oil, caraway, and coriander treated potatoes on day 2 of storage. The number of sprouted potatoes were significantly lower in caraway- and spearmint oil-treated potatoes compared to potatoes in the control group. On day 5, no peeps were observed in lemongrass-, caraway-, and spearmint oil-treated potatoes. It was observed that the carvone from the spearmint essential oil and the caraway oil effectively burnt off the peeps that grew on day 2, exhibiting sprout suppressant activity on potatoes. It was observed that coriander and untreated (control) potatoes continued to show higher sprout incidence. It is believed that the sprout suppression effect was primarily the result of the principle active component of the essential oils (e.g., carvone in spearmint essential oil and caraway seed oil, citral in lemongrass oil).

On day 7, no peeps were observed in caraway- and lemongrass oil-treated potatoes. Spearmint oil-potatoes showed low levels of sprouting. No sprout suppression activity was observed in untreated (control)- and coriander-treated potatoes. On day 9, no peeps were observed in lemongrass oil-treated potatoes. Caraway- and spearmint oil-treated potatoes showed low levels of sprouting. Untreated (control) and coriander oil-treated potatoes continued to increase in sprout incidence.

TABLE 10
Percentage of potatoes indicated as FAIL over the evaluation days

| | Evaluation Day | | | | |
|---|---|---|---|---|---|
| Group | 0 | 2 | 5 | 7 | 9 |
| Untreated Control | 0% | 30% | 85% | 92% | 97% |
| Spearmint | 0% | 11% | 0% | 1% | 2% |
| Caraway | 0% | 6% | 0% | 0% | 4% |
| Lemongrass | 0% | 0% | 0% | 0% | 0% |
| Coriander | 0% | 35% | 73% | 84% | 90% |

### Oil Release and Headspace Concentration

The headspace concentration of potato storage boxes treated with spearmint oil, caraway, lemongrass, and coriander were evaluated over time (Table 11). Spearmint oil-, caraway-, and lemongrass-treated boxes achieved a concentration of above 2.0 ppm throughout the 9 evaluation days. The coriander-treated boxes showed the lowest active ingredient concentration in the container headspace, which correlated with the average mass of active loss over time measured by weighing the mass of the sachets over time (Table 4). The negative values obtained from massing the sachets is believed to be due to the other compounds adsorbed by the matrix over time as it releases the actives loaded.

While headspace concentration of only the major active component present in a particular essential oil was measured, essential oils are typically made up of many other volatile and non-volatile components. For example, caraway has an about 35% limonene component that was not tracked through the GC headspace sampling in this Example. However, mass loss data collected via weighing of the sachet at each time point permitted measurement of release of all the components of the essential oils that were released over time.

TABLE 11
Concentration of main active component of each essential
oil hypothesized to possess sprout suppressant mechanisms
over maintained in a 15 L container over 9 days (ppm).

| | Evaluation Day | | | | |
|---|---|---|---|---|---|
| Group | 0 | 1 | 2 | 5 | 9 |
| Untreated Control | — | 0 | 0 | 0 | 0 |
| Spearmint | — | 3.0 | 6.1 | 8.5 | 10.5 |
| Caraway | — | 15.9 | 6.1 | 4.0 | 4.1 |
| Lemongrass | — | 2.0 | 3.0 | 3.2 | 4.4 |
| Coriander | — | 0 | 0.6 | 0.3 | 0 |

TABLE 12
Average mass of actives released over time (g)

| | Evaluation Day | | | | |
|---|---|---|---|---|---|
| Group | 0 | 2 | 5 | 7 | 9 |
| Untreated Control | — | — | — | — | — |
| Spearmint | 0 | 0.4817 | 0.7043 | 0.7910 | 0.8670 |
| Caraway | 0 | 0.5697 | 0.8227 | 0.8827 | 0.9553 |
| Lemongrass | 0 | 0.1667 | 0.2717 | 0.3190 | 0.3787 |
| Coriander | 0 | −0.0247 | −0.0157 | −0.0197 | −0.0150 |

### Conclusions

Spearmint oil, caraway, and lemongrass oil showed significant sprout suppression efficacy compared to untreated (control) and coriander. Without wishing to be bound by any particular theory, it is believed that the presence of an alpha-beta unsaturated carbonyl in each of the carvone of spearmint oil and caraway and citral of lemongrass oil contributes to their observed sprout suppressant efficacy.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of suppressing sprouts on produce, comprising:
releasing a sprout suppressant from a release device into a container containing the produce,
wherein the sprout suppressant in the container is maintained at a concentration of at least 1 ppm for a period of at least 3 days.

2. A method of suppressing sprouting on produce, comprising:
continuously exposing the produce, over a period of at least 3 days, to a concentration of at least 1 ppm of a sprout suppressant emanating from a release device.

3. The method of claim 2, further comprising:
placing the release device into a container containing the produce; and
releasing the sprout suppressant into the container, wherein the sprout suppressant in the container is maintained at a concentration of at least 1 ppm for a period of at least 3 days.

4. The method of claim 3, wherein the sprout suppressant in the container is maintained at a concentration of at least 1 ppm for a period of at least 6 days.

5-23. (canceled)

24. The method of claim 3, wherein the sprout suppressant in the container is maintained at a concentration of up to 10 ppm for a period of at least 3 days.

25. The method of claim 2, wherein the produce consists of post-harvest agricultural and/or horticultural products that have a propensity toward sprouting.

26. The method of claim 2, wherein the produce comprises potatoes.

27. (canceled)

28. The method of claim 2, wherein the sprout suppressant is released from the release device in the vapor-phase or gas-phase.

29-31. (canceled)

32. The method of claim 2, wherein the release device comprises:
a composition comprising a porous adsorbent material impregnated with sprout suppressant below a wet point of the porous adsorbent material, the composition incorporated into a form factor comprising one or more of a packet, pouch, sachet, or pad.

33-48. (canceled)

49. The method of claim 2, wherein the sprout suppressant comprises at least one of an essential oil or botanical extract.

50. (canceled)

51. The method of claim 2, wherein the sprout suppressant comprises an essential oil.

52-61. (canceled)

62. The method of claim 2, wherein the release device comprises a porous adsorbent material.

63. (canceled)

64. The method of claim 62, wherein the porous adsorbent material has a total chemical surface area, internal and external, of at least 100 m²/g.

65-68. (canceled)

69. The method of claim 62, wherein the porous adsorbent material comprises a carbon material and/or a silicate material.

70. (canceled)

71. The method of claim 62, wherein the porous adsorbent material comprises a carbon material.

72. (canceled)

73. The method of claim 71, wherein the carbon material comprises activated carbon.

74. (canceled)

75. The method of claim 62, wherein the porous adsorbent material comprises a silicate material.

76-77. (canceled)

78. The method of claim 75, wherein the silicate material comprises silica.

79. (canceled)

80. The method of claim 2, further comprising: wherein the release device is in a container comprising the produce.

81-88. (canceled)

89. A release device, comprising:
a form factor; and
a composition, comprising:
a porous adsorbent material; and
a sprout suppressant present in the porous adsorbent material.

90-218. (canceled)

219. The method of claim 2, wherein the sprout suppressant comprises a terpene and/or terpenoid.

220. The method of claim 2, wherein the sprout suppressant comprises spearmint oil, caraway oil, caraway seed oil, dill seed oil, orange peel oil, mandarin orange peel oil, kuromoji oil, gingergrass oil, peppermint oil, clove oil, garlic oil, ruta chalepensis L. oil, eucalyptus oil, coriander oil, sagebrush oil, rosemary oil, muna oil, jasmine oil, methyl jasmonate, 3-decen-2-one, 1,4-dimethylnaphthalene, carvone, and/or rape oil.

221. The method of claim 2, wherein the sprout suppressant comprises carvone.

222. The method of claim 221, wherein at least some of the carvone is (R)-(−)-carvone.

223. The method of claim 221, wherein at least some of the carvone is (S)-(+)-carvone.

224. The method of claim 2, wherein the sprout suppressant comprises spearmint oil or spearmint extract.

225. The method of claim 2, wherein the sprout suppressant comprises caraway seed oil.

226. The method of claim 2, wherein the sprout suppressant comprises citral.

227. The method of claim 2, wherein the sprout suppressant comprises lemongrass.

228. The method of claim 62, wherein the release device further comprises a supplemental material within a bulk of the porous adsorbent material, wherein the sprout suppressant is more volatile than the supplemental material.

229. The method of claim 228, wherein the supplemental material comprises an oil.
